(19) United States
(12) Patent Application Publication
(10) Pub. No.: US 2001/0047335 A1
(43) Pub. Date: Nov. 29, 2001

(54) Secure payment method and apparatus

(76) Inventors: Martin Arndt, London (GB); Christopher Iain Johnston, London (GB)

Correspondence Address: GOTTLIEB RACKMAN & REISMAN PC, 270 MADISON AVENUE, 8TH FLOOR, NEW YORK, NY, 100160601

(21) Appl. No.: 09/809,362

(22) Filed: Mar. 15, 2001

(30) Foreign Application Priority Data
Apr. 28, 2000 (GB) 0010422.4
Feb. 28, 2001 (GB) 0104956.8

(51) Int. Cl. G06F 17/60

(52) U.S. Cl. 705/44; 705/75

(57) ABSTRACT

A secure transaction method and system is disclosed to allow for goods or services to be paid for using a limited use credit card number. A limited use credit card number is generated by a customer using a number generating device. The number and user identification information is sent to a validation apparatus to validate the generated number against the user identification information. If the validation process is successful, the limited use credit card number is stored to be used for later transaction authorisation. The successfully validated limited use credit card number is then used in a transaction authorisation process to obtain authorisation for a transaction. The validation apparatus receives a limited use credit card number in a request to authorise the transaction, compares the received number with stored numbers, and authorises the transaction in dependence upon the outcome of the comparison.

The present invention generally relates to a method and apparatus for making secure payments for goods and/or services. In particular the present invention relates to a method and apparatus for making secure payments for goods and/or services using a credit card number which is generated by a customer and which can only be used for a limited time and/or for a limited number of transactions.

In view of the prevalent use of the Internet and the huge growth in e-commerce, a great deal of attention has been directed to methods of providing secure methods of payment for goods and services. The most common method of payment currently used is by credit card. This method however exposes the customer's credit card number over the Internet. The instances of fraud have increased dramatically. This is a problem for both the customer and the credit card authorities.

With a view to reducing the risks by exposing a credit card number to the Internet for the payment for goods or services, limited use credit card number have been developed. For instance WO99/49424 discloses one of a number of similar a credit card systems in which a central processing system holds a pool of limited use credit card numbers that can be assigned to a customer. Initially a customer must register by giving their credit card number to be used for payment. This information is stored limited use credit card numbers are issued against the real credit card number. Thus once a user has registered, they can request a new limited use credit card number at any time by logging in. A limited use credit card or just the number can then be issued. Thus the limited use credit card can be used for transactions and the real credit card number is not exposed to the Internet.

Whilst these systems of the prior art are an improvement over the use of real credit card numbers over the Internet, they are still vulnerable to fraud. For instance it is possible for a fraudster to obtain the login details for a customer, thereby enabling them to request limited use credit card numbers. Further, the limited use credit card numbers are not unique, but instead are drawn from a pool. This increases the likelihood of a fraudster being able to obtain a valid limited use credit card number.

It is an object of the present invention to overcome limitations of the prior art and to provide a secure system and method of payment for goods or services.

In accordance with one aspect the present invention provides a system and method for securely paying for good or services. Apparatus in the possession of a customer is used to generate a limited use credit card number. The limited use credit card number and customer identification information is sent to a validation apparatus over a communications network. At the validation apparatus, the generated limited use credit card number is validated using the customer identification information, and if the generated limited use credit card number is determined to be valid, it is stored for payment for goods or services at the validation apparatus. The customer uses the limited use credit card number for paying for goods or services. The purchase is then authorised by comparing the credit card number used for the purchase with the limited use credit card number stored at the validation apparatus.

Thus this aspect of the present invention requires a customer to know something i.e. the customer identification information such as a username (or user ID) and password (or Personal Identification Number—PIN) and to have possession of an apparatus for the generation of the limited use credit card number since the validation process for the limited use credit card number requires both sets of information. Thus this provides a higher level of security since a fraudster cannot acquire a limited use credit card simply by obtaining the user identification information.

In this aspect of the present invention, the generated number is dual purpose and comprises a valid credit card number that can be processed using the conventional credit card authorisation system and includes user authentication code for the authentication of the user during the validation process.

The present invention also benefits from the use of limited use credit card numbers in the format of a conventional credit card number. This enables a merchant and the customer to handle the numbers in the usual way for purchases and for transaction authorisations. The limited use credit card numbers can be handled by the credit card networks in the usual way and finally referred to the validation apparatus for transaction authorisation. Credit card numbers have a predefined format that allows them to be handled within the conventional transaction authorisation system. The format comprises a prefix of numbers termed a bank identification number (BIN) used to identify the bank to be used for authorising the transaction i.e. where to route the authorisation request, and a suffix number termed the Look-up number (LUN). Thus in one embodiment of the present invention the limited use credit card number comprises at least a prefix of standard form added to the beginning of the generated number.

The limited use credit card number in this invention can be of limited use in that it has a limited lifetime and/or it can only be used for a limited number of transactions e.g. a single transaction. Further, the term ‘limited use credit card number’ is intended to cover any type of number used for accessing debit or credit facilities, such as a debit card number, a credit card number, a charge card number or an ATM card number.

In a preferred embodiment the limited use credit card number is generated at the apparatus used by the customer by encrypting apparatus identification information (e.g. a serial number for the apparatus of the software module loaded on the apparatus) using a key. Also in a preferred embodiment of the invention the limited use credit card number is generated by also encrypting time information (e.g. a time window such as a 2 minute window during which the encryption process takes place. Thus in one embodiment of the present invention, the limited use credit card number can contain information on the apparatus user for generation of the limited use credit card number and/or the time of generation of the limited use credit card number. This information significantly increases security since it provides a more secure validation process. Thus in accordance with one embodiment of the present invention, the limited use credit card had a limited lifetime and can thus be termed a dynamic credit card number.

In one embodiment of the present invention, the limited use credit card number is sent straight to the validation apparatus after generation at the customer's apparatus for validation. Thus in this embodiment a customer can prevalidate any number of limited use credit card numbers for later purchases. These limited use credit card numbers can then be used later for purchases in a conventional manner. The apparatus used by the customer can write the limited use credit card number to a conventional carrier medium such as a magnetic card for use by the customer in the conventional manner, or it can simply output e.g. display the number for use by the customer over a communications network such as the Internet or telephone network. In this embodiment it is also possible for the limited use credit card number to have a lifetime. The validation must however be carried out at the time of transaction authorisation. Thus when a limited life credit card number is sent via the conventional credit card authorisation system for authorisation of a transaction, transaction information including the time of the transaction will be available. Thus, at the point of authorisation, the validation server can check to determine whether the time of generation of the limited use credit card number is too long ago for the authorisation of the transaction using the limited use credit card number.

In another embodiment of the present invention, the limited use credit card number is generated and validated at the time of purchase. In this embodiment, when a customer wishing to purchase goods or services contacts the merchant, they are referred to a secure payment apparatus for the input of the limited use credit card number generated at the customer owned machine and user identification information such as user ID or username and password or PIN. The time of request for the purchase is determined by the secure payment apparatus and this, together with the input limited use credit card number and user identification information is then passes to the validation apparatus for the validation of the limited use credit card number by reference to the user identification information. Thus in this embodiment it is not possible for limited use credit cards to be obtained in advance of their requirement as in the previous embodiment. Thus this further enhances security.

In a preferred embodiment of the invention, merchant identification information (e.g. a merchant certificate or ID) is received from the merchant by the secure payment apparatus and this is sent together with the limited use credit card number, user identification information and time sent to the validation apparatus for validation. In this embodiment, the limited use credit card number generated by the customer's apparatus receives the merchant identification information (either automatically or it is manually input by the customer) and this is used to generate the limited use credit card number.

In an embodiment of the present invention, transaction information is transmitted by the merchant to the secure payment server and the secure payment server passes this together with the other information to the validation server for use in the authorisation of the transaction via the conventional authorisation route.

In one embodiment of the present invention, the limited use credit card number can be generated by the customer's apparatus to include user identification information as well as information identifying the customer's apparatus and the time information. This further enhances security.

The validation apparatus of this aspect of the present invention can be implemented by any suitable specialist hardware or programmed hardware. The present invention thus encompasses any suitably programmed apparatus and the program code provided to the apparatus. The present invention can therefore be embodied as computer program code provided on a suitable carrier medium such as a transient carrier medium e.g. an electrical, optical, microwave or radio frequency signal (a signal carrying the program code over a network such as the internet is a specific example), or a storage medium such as a floppy disk, CD ROM, magnetic tape device or a programmable read only memory device.

In another aspect, the present invention provides apparatus and a method for generating a limited use credit card number in which apparatus identification information for identifying the apparatus, and an encryption key are stored. Time identification information is generated and encrypted together with the apparatus identification information using the encryption key to generate a multiple digit number. The generated number is then used to form a limited use credit card number containing at least a part of the encrypted number and the generated limited use credit card number is output.

In one embodiment the limited use credit card number is generated by fitting the multiple digit number between a number of standard prefix and suffix digits. The fitting can be achieved by truncating the multiple digit number.

In one embodiment of the present invention, the multiple digit number can be generated by encrypting user identification information input by a user e.g. a user ID, username, password and/or PIN.

In another embodiment of the present invention, in order for the limited use credit card number to be generated, the user must input user identification information such as a username and password or PIN. This is compared with user identification information stored within the apparatus to determine if it is valid and if so to generate the limited use credit card number.

In one embodiment of the present invention, the limited use credit card number is output on a display to allow a user to get the number validated by sending if over a communications network to a validation apparatus. In another embodiment of the present invention, the apparatus includes a communications interface to allow the generated limited use credit card number to be automatically transmitted to the validation apparatus.

This aspect of the present invention can be implemented by any suitable specialist hardware or programmed hardware. The present invention encompasses any suitably programmed apparatus and the program code provided to the apparatus. The present invention can therefore be embodied as computer program code provided on a suitable carrier medium such as a transient carrier medium e.g. an electrical, optical, microwave or radio frequency signal (a signal carrying the program code over a network such as the internet is a specific example), or a storage medium such as a floppy disk, CD ROM, magnetic tape device or a programmable read only memory device. The apparatus can comprise any suitable device carried by a user such as a mobile telephone, a personal digital assistant or a small computer e.g. a laptop, notebook or sub notebook computer. The apparatus can also comprise a conventional programmable computer with a suitable program module loaded on it to generate the limited use credit card number. Also the apparatus can comprise a dedicated device such as a smart card with a display device.

Where the apparatus has a telecommunications interface e.g. a mobile telephone or a computer having a modem of other Internet connection e.g. a local area network connection, the apparatus is able to automatically send the generated limited use credit card number to the validation apparatus.

Embodiments of the present invention will now be described with reference to the accompanying drawings, in which:

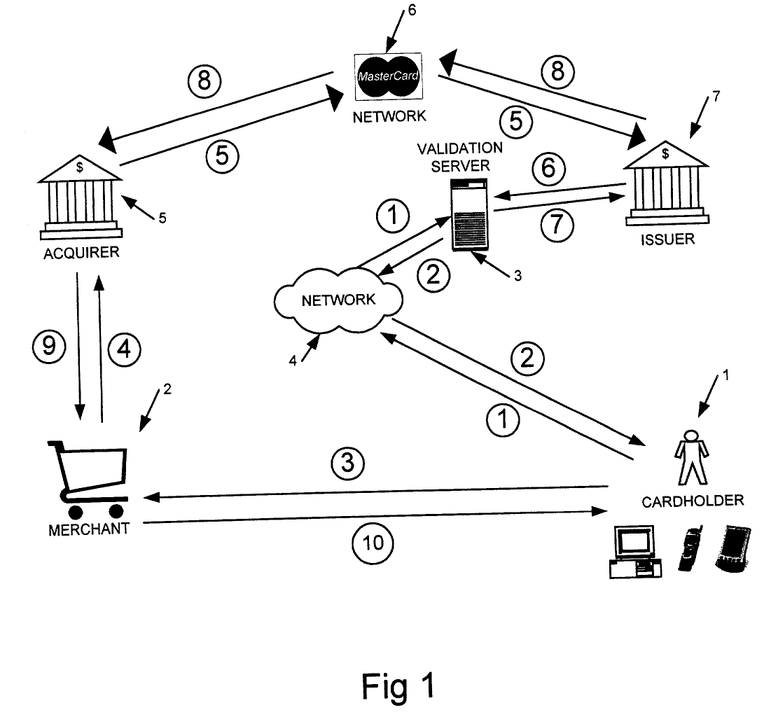

FIG. 1 is a schematic diagram illustrating the principles of a first embodiment of the present invention;

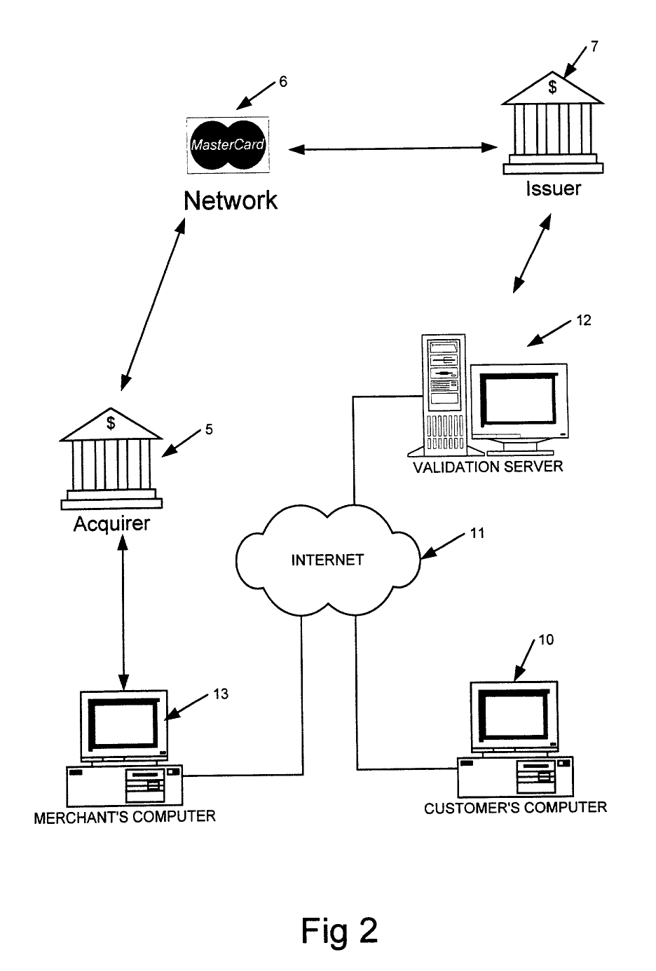

FIG. 2 is a schematic diagram of a system for implementing the first embodiment of the present invention;

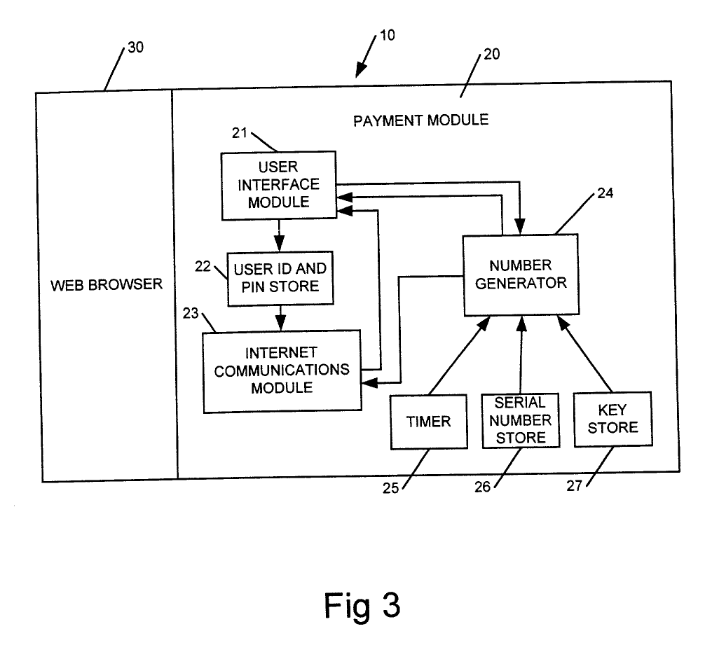

FIG. 3 is a schematic diagram of a limited use credit card number generator apparatus for use in the first embodiment of the present invention;

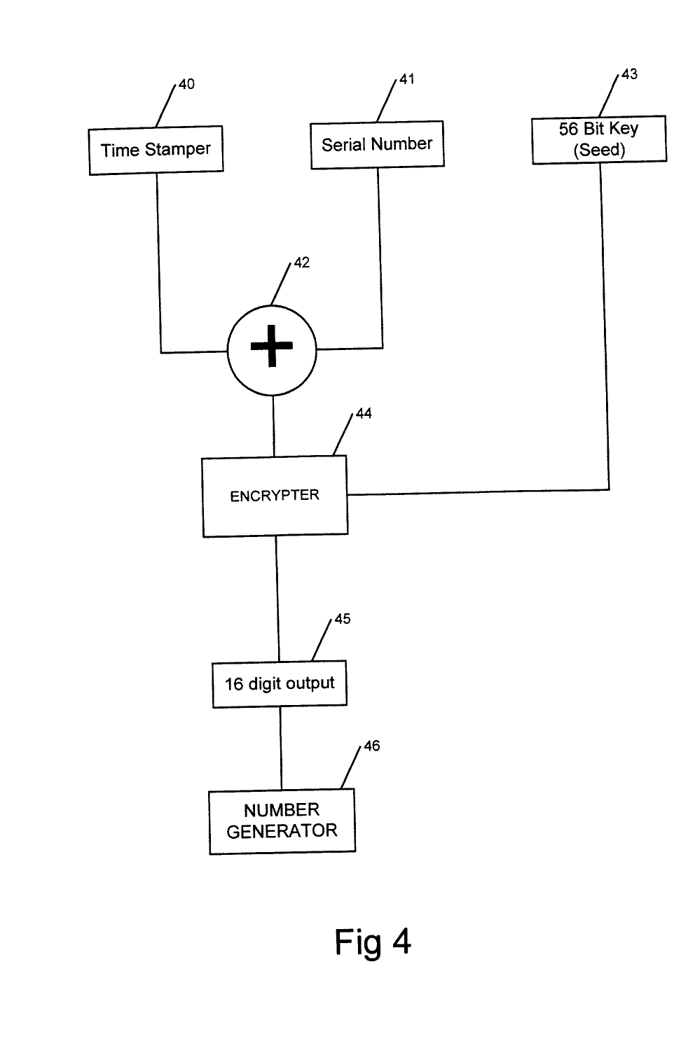

FIG. 4 is a schematic diagram of an encryption algorithm used in the limited use number generator apparatus in the first embodiment of the present invention;

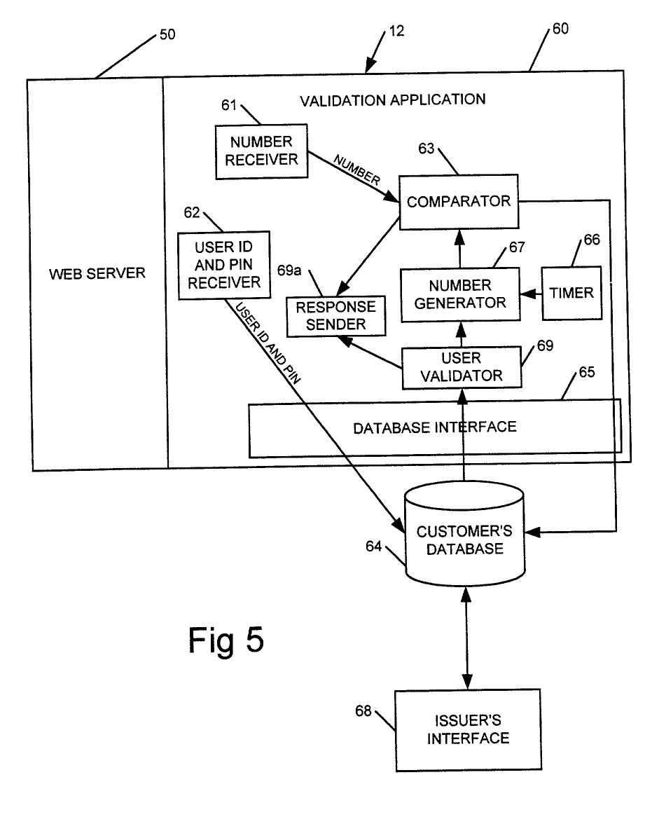

FIG. 5 is a schematic diagram of a validation apparatus for use in the first embodiment of the present invention;

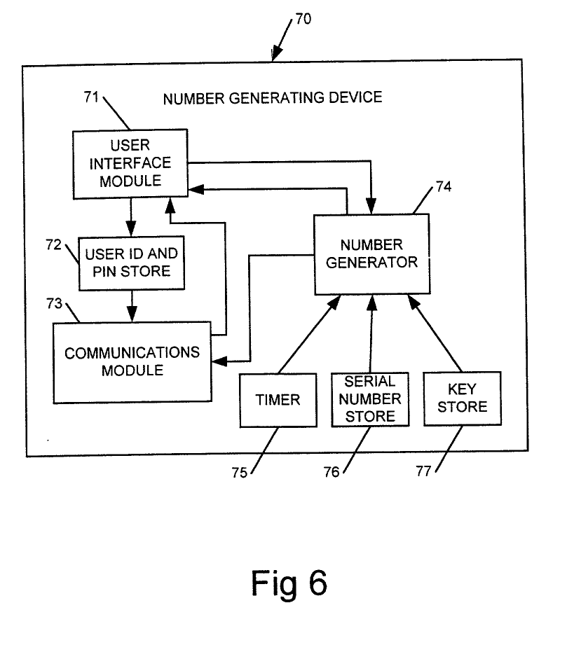

FIG. 6 is a schematic diagram of an alternative limited use credit card number generator apparatus for use in the first embodiment of the present invention;

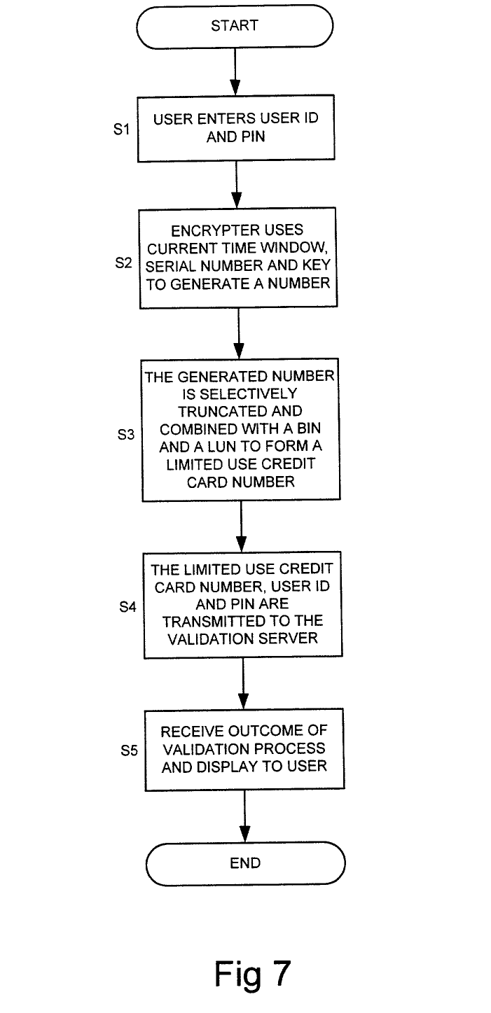

FIG. 7 is a flow diagram illustrating the method carried out by the limited use credit card number generator apparatus in the first embodiment of the present invention;

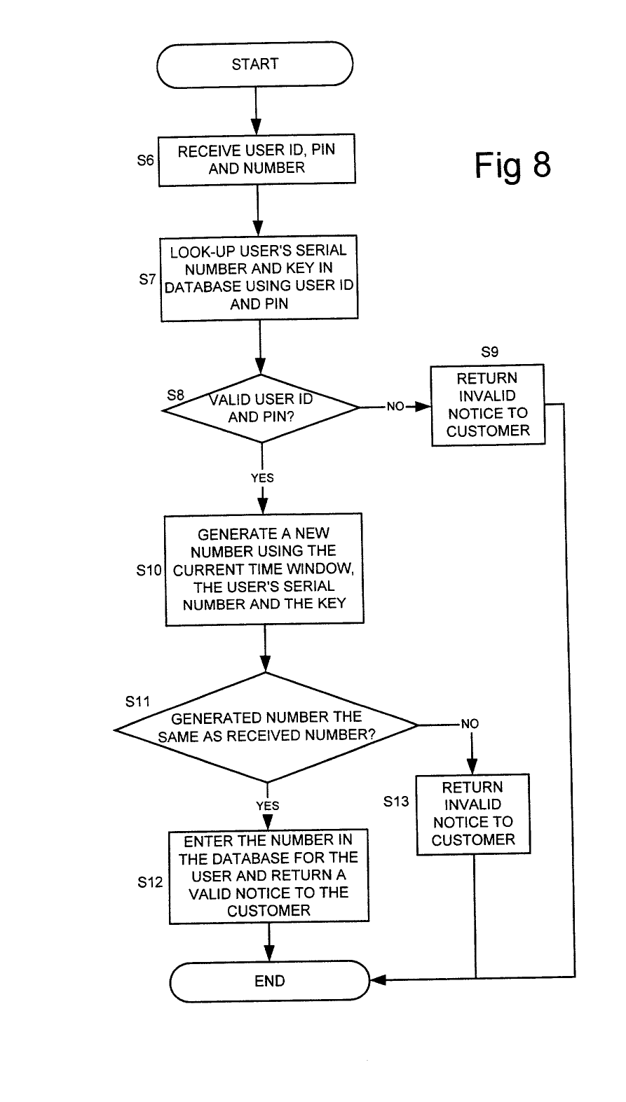

FIG. 8 is a flow diagram illustrating the validation method carried out by the validation apparatus in the first embodiment of the present invention;

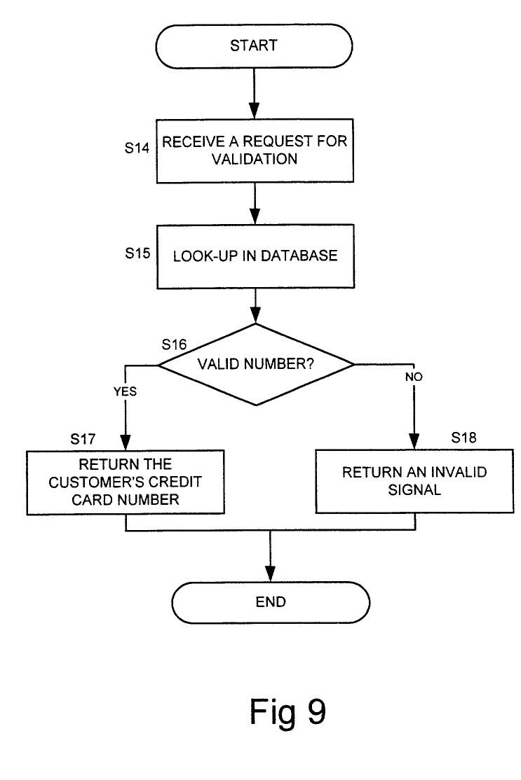

FIG. 9 is a flow diagram illustrating the transaction authorisation method carried out by the validation apparatus in the first embodiment of the present invention;

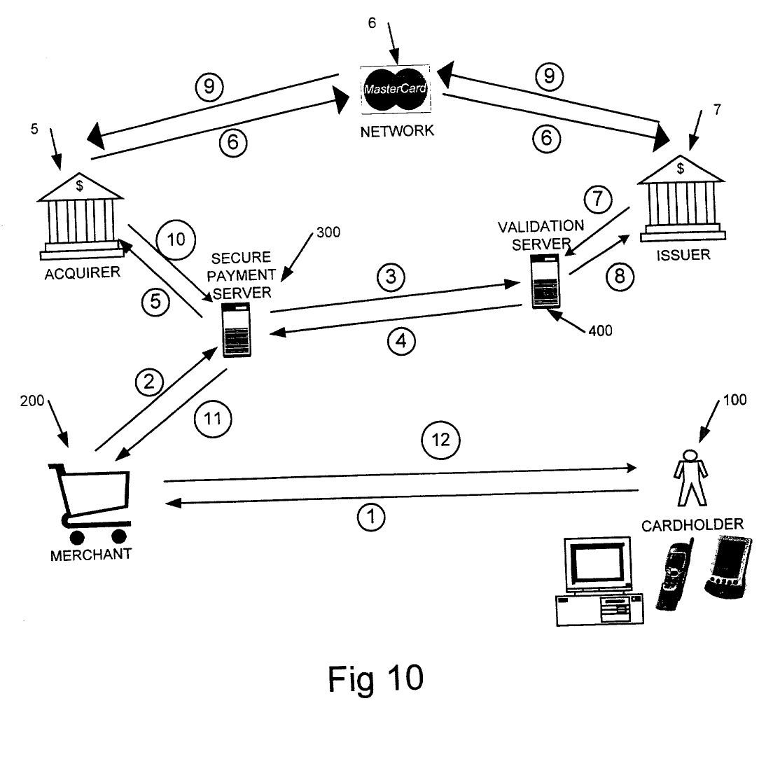

FIG. 10 is a schematic diagram illustrating the principles of a second embodiment of the present invention;

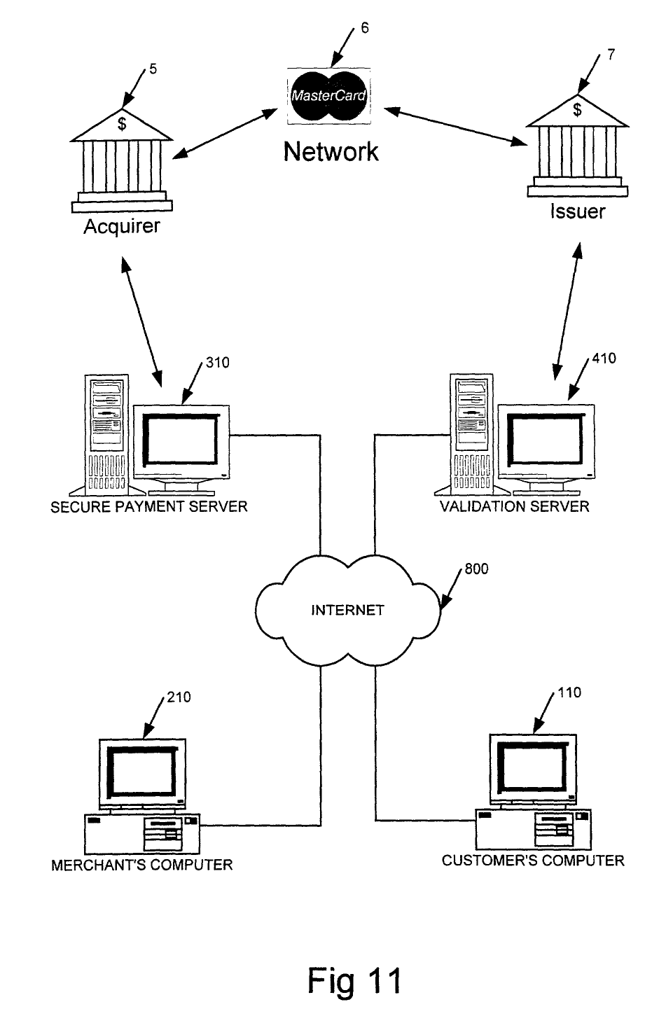

FIG. 11 is a schematic diagram of a system for implementing the second embodiment of the present invention;

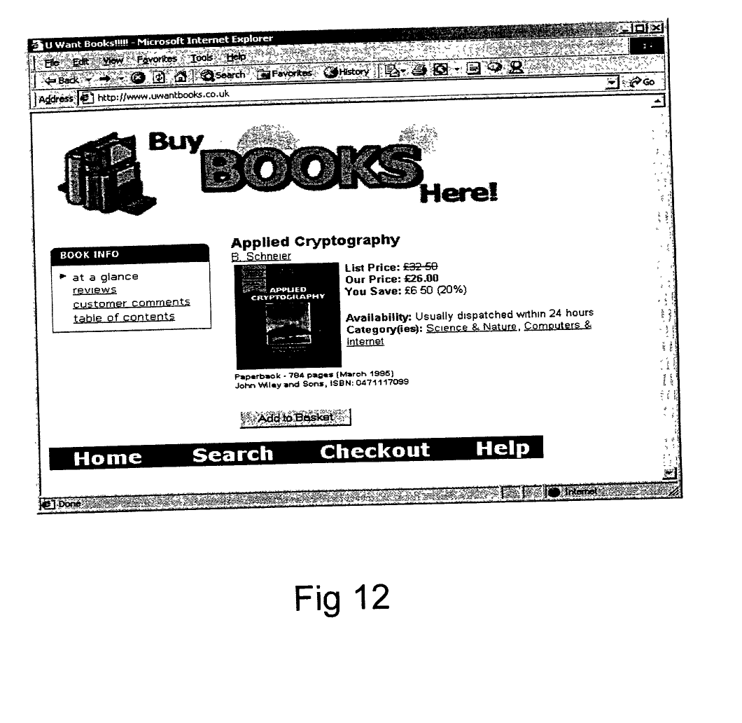

FIG. 12 is a picture of a first screen display provided to a customer selecting to purchase a book over the Internet from a merchant using the system of the second embodiment of the present invention;

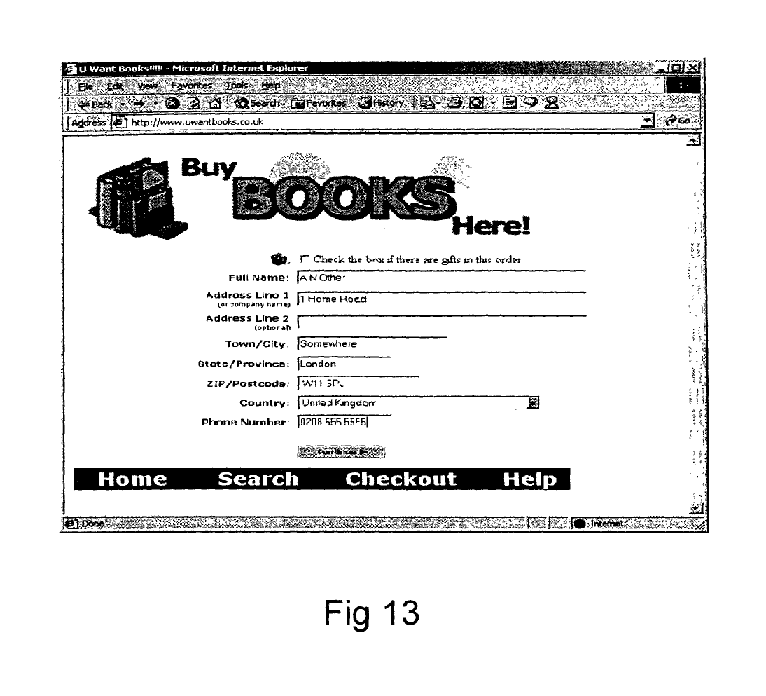

FIG. 13 is a picture of the next screen display provided to the customer to allow the customer to enter delivery details using the system of the second embodiment of the present invention;

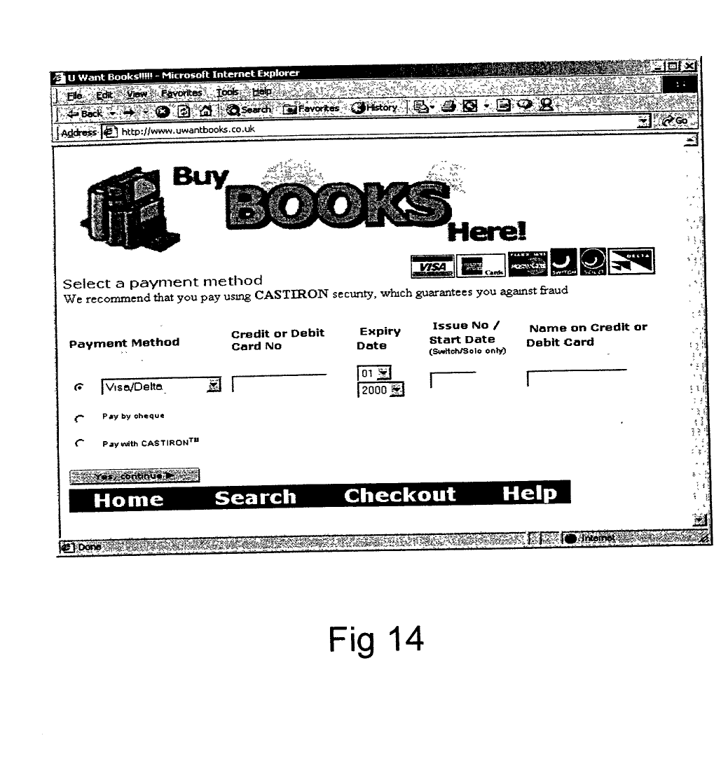

FIG. 14 is a picture of the next screen display provided to a customer to allow the customer to select the method of payment using the system of the second embodiment of the present invention;

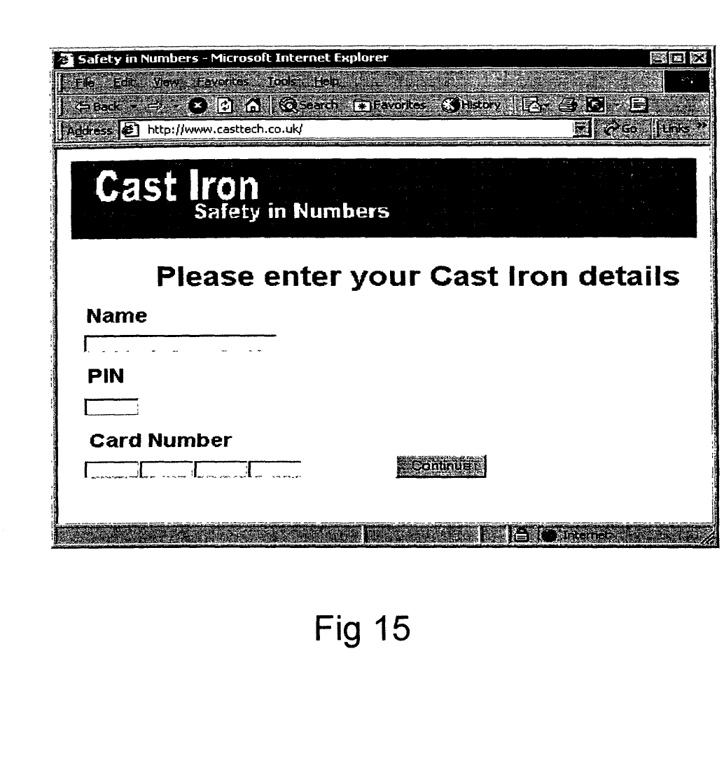

FIG. 15 is a picture of the next screen display provided to a customer to allow the customer to enter their user identification information and limited use credit card number using the system of the second embodiment of the present invention;

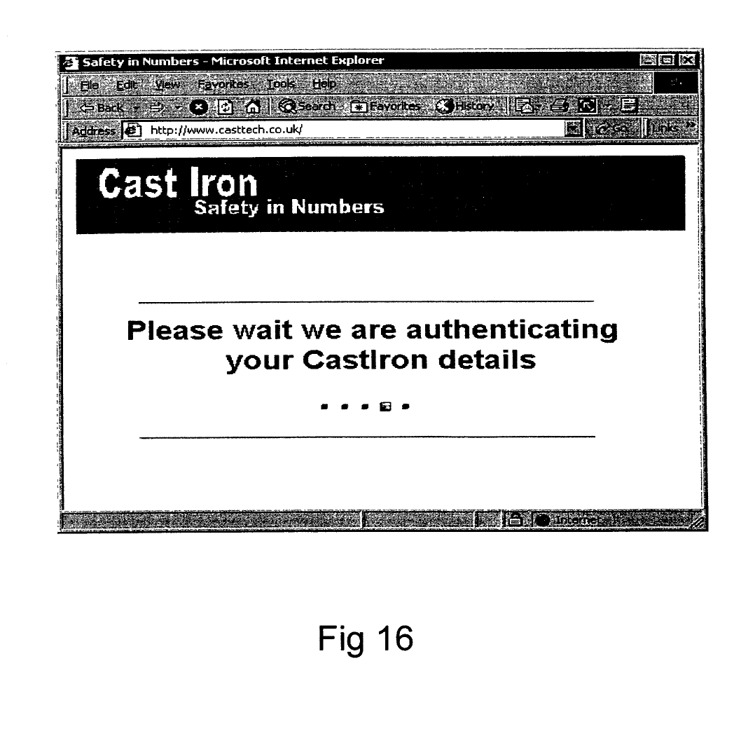

FIG. 16 is a picture of the next screen display provided to a customer informing them that their limited use credit card number is being validated and the transaction authorised using the system of the second embodiment of the present invention;

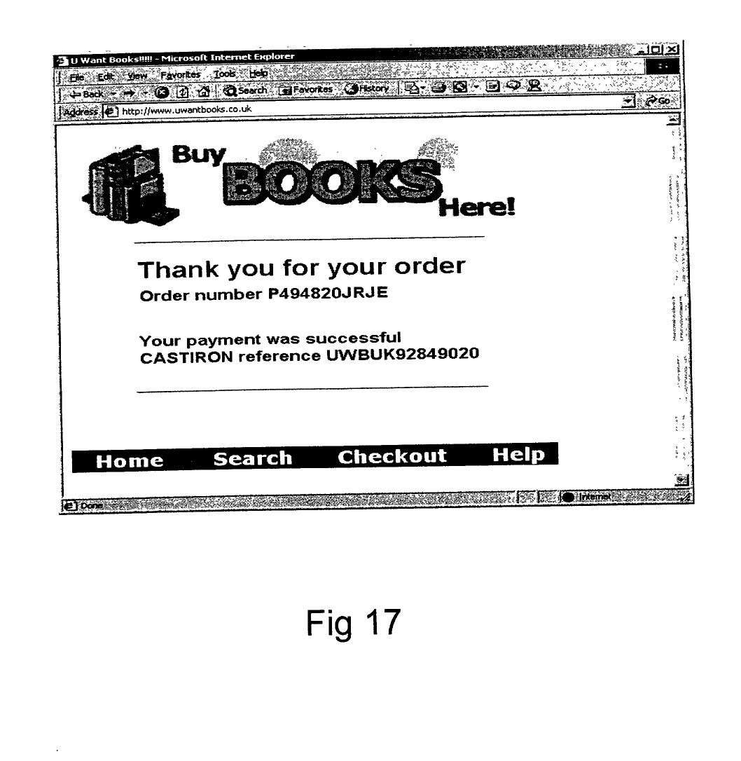

FIG. 17 is a picture of the next screen display provided to a customer to inform them that the transaction has been successfully authorised and the order has been processed using the system of the second embodiment of the present invention;

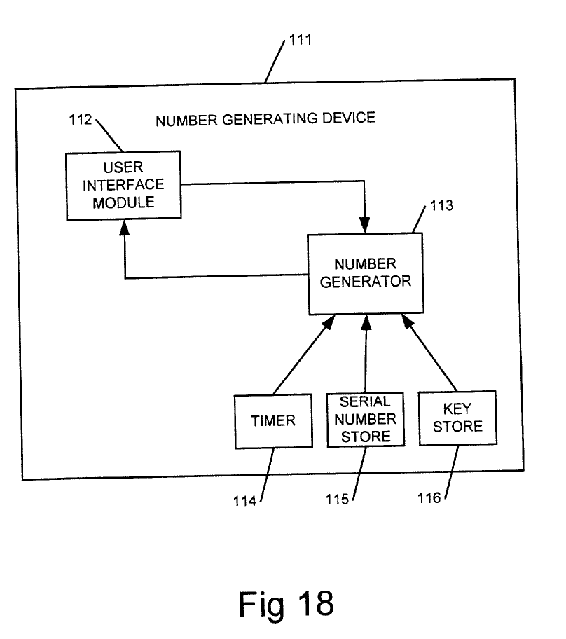

FIG. 18 is a schematic diagram of a limited use credit card number generator apparatus for use in the second embodiment of the present invention;

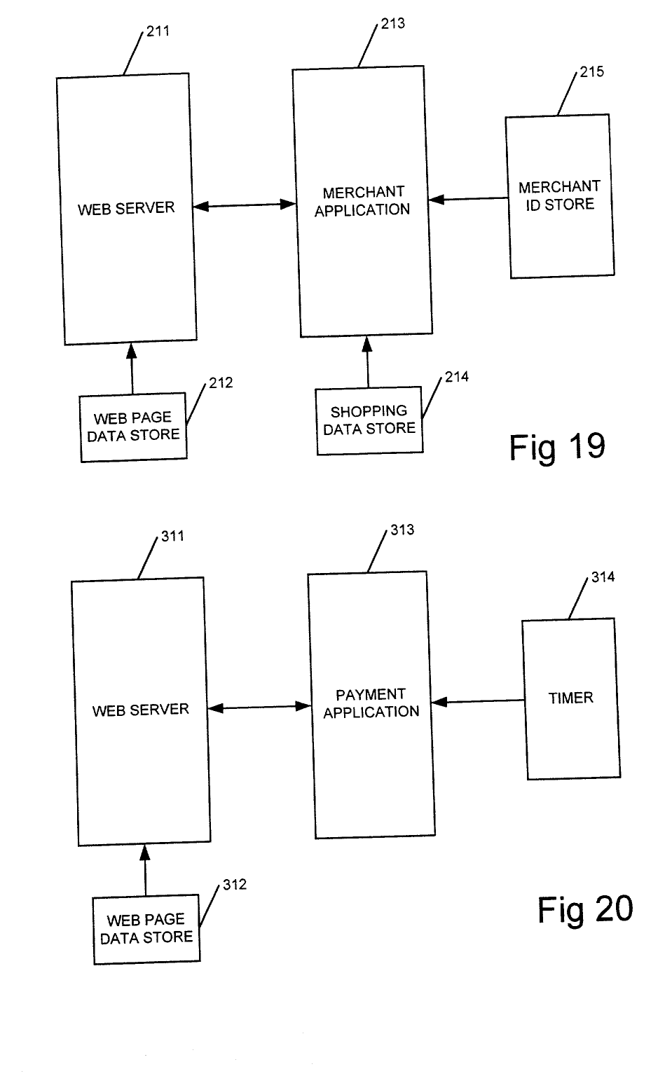

FIG. 19 is a schematic diagram of the merchant apparatus for use in the second embodiment of the present invention;

FIG. 20 is a schematic diagram of the secure payment apparatus for use in the second embodiment of the present invention;

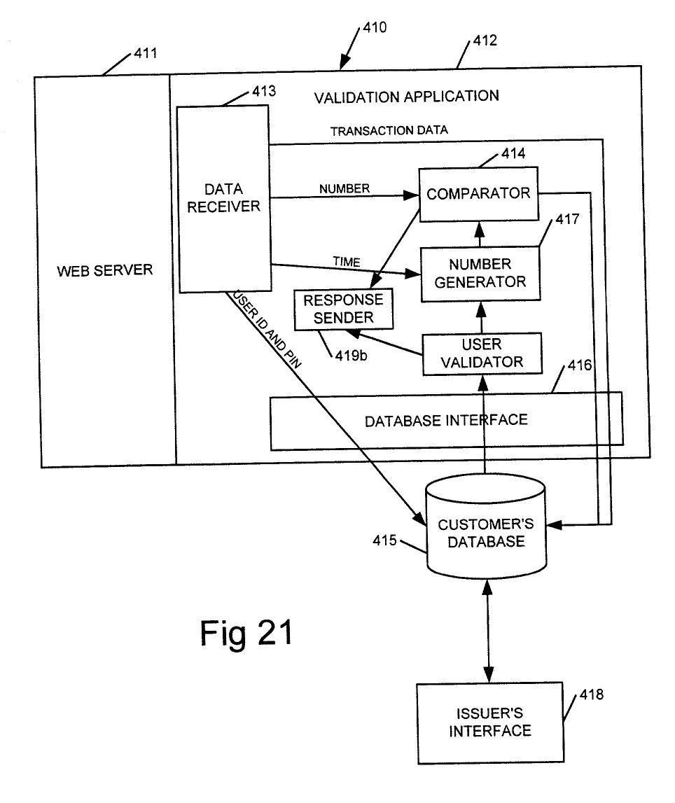

FIG. 21 is a schematic diagram of a validation apparatus for use in the second embodiment of the present invention;

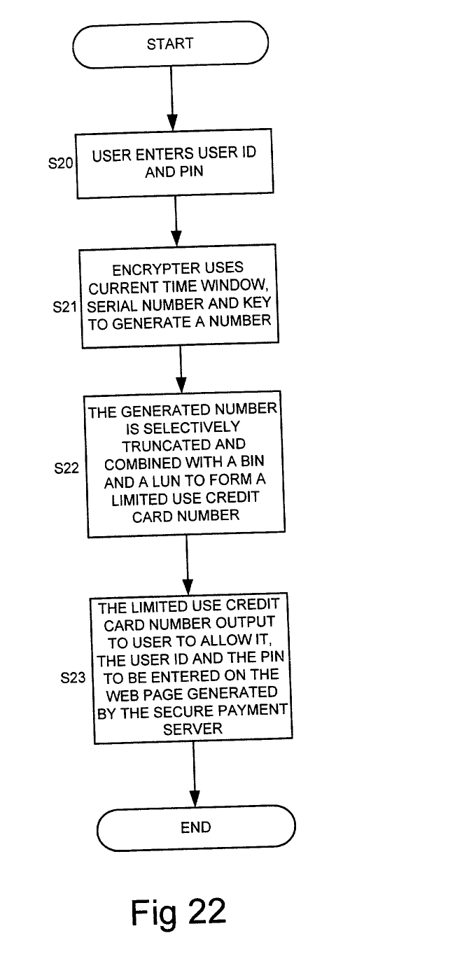

FIG. 22 is a flow diagram illustrating the method carried out by the user operating the limited use credit card number generator apparatus in accordance with the second embodiment of the present invention;

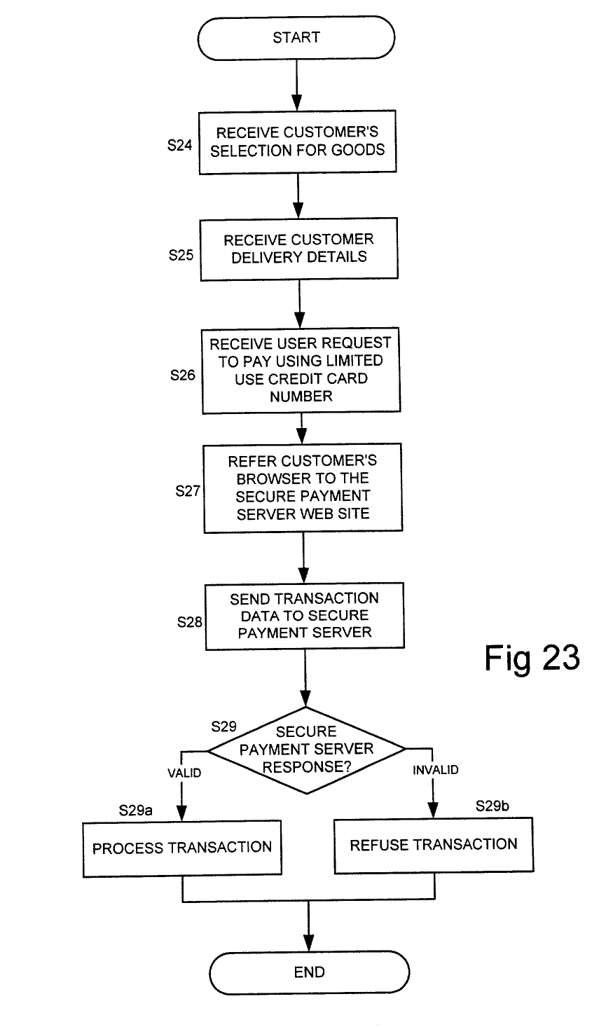

FIG. 23 is a flow diagram illustrating the method carried out by the merchant apparatus in accordance with the second embodiment of the present invention;

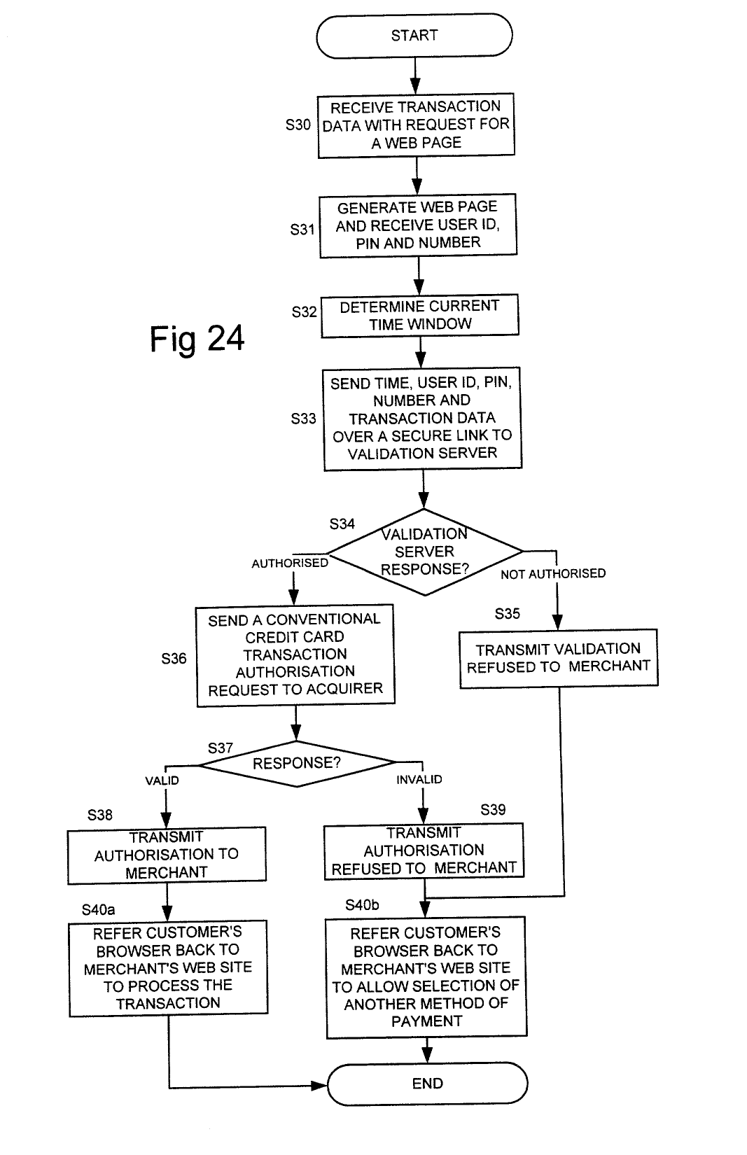

FIG. 24 is a flow diagram illustrating the method carried out by the secure payment apparatus in accordance with the second embodiment of the present invention;

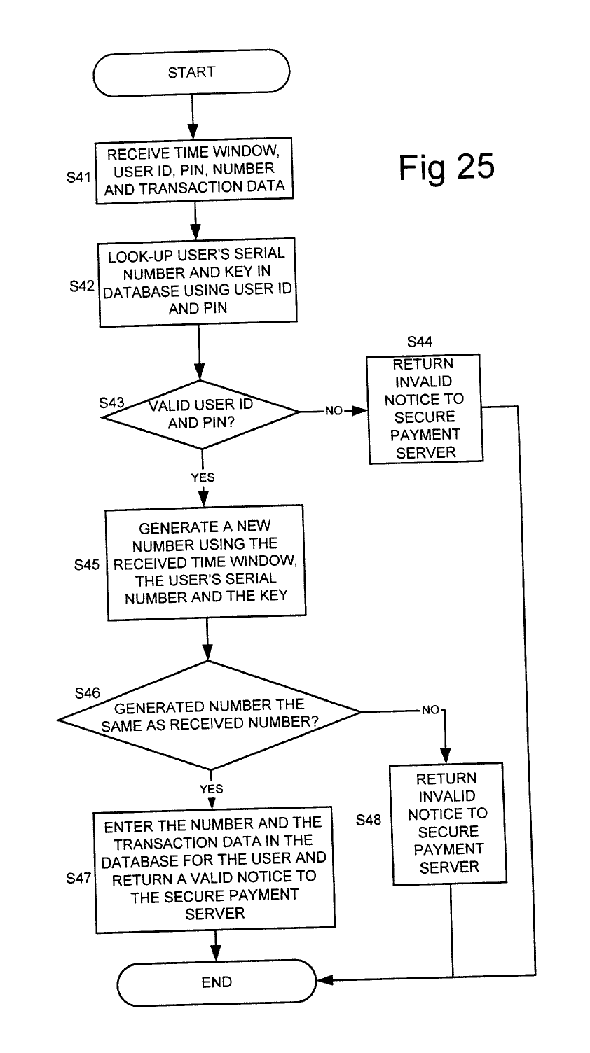

FIG. 25 is a flow diagram illustrating the validation method carried out by the validation apparatus in the second embodiment of the present invention; and

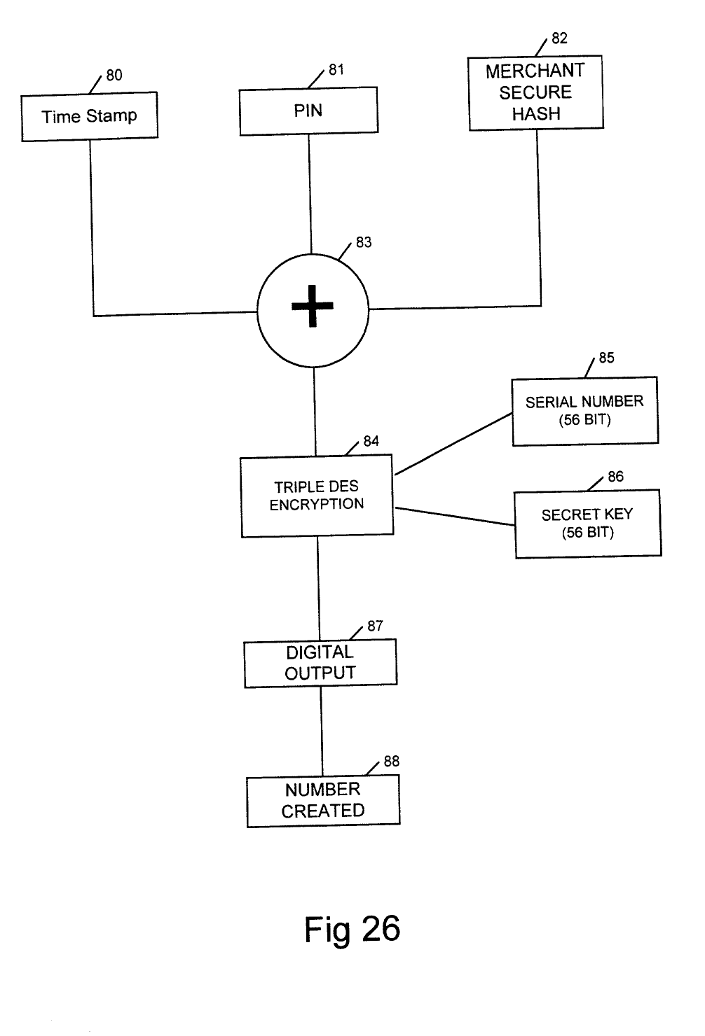

FIG. 26 is a schematic diagram of an alternative encryption algorithm for use in the limited use number generator apparatus in either of the embodiments of the present invention.

A first embodiment of the present invention will now be described with reference to FIGS. 1 to 9 of the drawings.

FIG. 1 is a diagram illustrating schematically the principles of the first embodiment of the present invention. A cardholder 1 is a person who has a conventional credit or debit card i.e. an account with a funding institution such as a bank. However, the cardholder 1 does not wish to expose their card number to potential fraud and thus wishes to obtain a limited use credit card number. In order to benefit from the inventive system, the cardholder must initially register for the service. The registration process will require the cardholder 1 to enter personal details including their credit or debit card number so that a data record is created in the validation server for the cardholder. The user can also select or be issued with a user ID and PIN. This registration process can be performed in any conventional way such as over the telephone or by mail to avoid having to send credit card details over an insecure network such as the Internet.

Once the cardholder 1 has registered for the service, the user will be provided with a limited use credit card generator. This can comprise a dedicated hardware device such as a smart card (with a display or without a display but useable with a card reader, envelope device with a display, or a computer), a multipurpose device such as a mobile telephone handset or a personal digital assistant (e.g. a Palm (trademark)), or program code for loading on a suitable programmable device such as a general purpose computer, a personal digital assistant or a mobile telephone handset. The program code can be provided to the cardholder 1 in any conventional manner such as on a storage medium such as a floppy disk, CD ROM, magnetic tape device, or a solid-state memory device, or as a signal e.g. by downloading the program code from a server over the Internet.

When a cardholder wishes to make a purchase using the service, they must initially obtain a limited use credit card number. If the limited use credit card is limited to a single use i.e. a single transaction, they may obtain a number of limited use credit card numbers. In order to obtain a limited use credit card number, the cardholder must use the device or program code to generate the limited use credit card number. The cardholder must also input user identification information such as a username and password or PIN. The limited use credit card number generating apparatus used by the cardholder will then automatically send (1) the generated limited use credit card number and the entered user identification information over a communications network 4 to a validation apparatus comprising a validation server computer 3. The validation server 3 will then perform a validation process using the received user identification information and limited use credit card number and will return (2) a response to the cardholder's apparatus indicating the outcome of the validation process. If the received outcome indicates that the limited user credit card number has been validated, the cardholder can then store this number for later use. A cardholder could thus perform this process a number of times to obtain a number of limited use credit card numbers. Since the generation process takes the time of generation into account (as will be described in more detail hereinafter), the number generated each time will be different so long as there is a period between the generation processes. This is because the generation process uses time as time frames as will become clearer later.

Having obtained a limited use credit card number a cardholder is now able to use the number as if it were a conventional credit or debit card number. It is possible for the apparatus used by the cardholder 1 to include a card-issuing device to enable the cardholder to be provided with a temporary physical credit card. This will enable the cardholder to make a purchase from the merchant 2 using the temporary credit card in a conventional manner. The preferred method is however simply the issuance of the number to allow the cardholder 1 to send (3) the number to the merchant 2 for the purchase of goods or services. The credit card number can be sent to the merchant using any communications channel such as a telephone or using the Internet to access the web site of the merchant. Because the credit card number is a limited use number, the risk to the cardholder 1 of fraudulent use of the card number is greatly reduced. Thus even if the number is fraudulently obtained as a result of its exposure over the Internet, the number can only be used for a limited number of transactions, preferably a single transaction, and/or the number is only valid for a limited period of time. Further, because of the generation method and the validation process, it is very difficult for a fraudster to successfully generate fraudulent valid limited use credit card numbers.

Once the merchant has received the limited use credit card number as a method of payment for goods or services, they need not be aware that it is a limited use credit card number because it has the same format as a conventional credit card number. They therefore treat the number as a conventional credit card number and send it (4) to an acquirer 5 in the conventional manner for the authorisation of the over the credit card authorisation network 6. The prefix digits in the number (the bank identification number—BIN) identify the issuer 7 responsible for the authorisation process. In the present invention the limited use credit card number is generated with prefix digits to route (5) the number during the authorisation process to a financial institution (issuer 7) in co-operating with the operator of the validation server 3 to provide the service. The issuer 7 will then send (6) the limited use credit card number to the validation server 7. The validation server 7 will perform a validation process by looking up a conventional credit card number corresponding to the limited use credit card number and return (7) a conventional credit card number to the issuer 7 if this is available. Since the number received by the validation server 3 from the issuer 7 is a limited use credit card number, once the number has been used i.e. used to return a conventional credit card number for authorising a transaction, it must be flagged accordingly. For instance, in the preferred embodiment the number is a single use number, and thus it is deleted or marked appropriately to prevent it being useable again. If no conventional credit card number is returned to the issuer 7, the authorisation will fail. If a conventional credit card number is returned it is used to authorise the transaction in the conventional manner i.e. by performing the conventional credit checks. The result of the validation by the issuer 7 will be sent (8) back over the network 6 to the acquirer 5 which will in turn pass (9) the result to the merchant 2. The merchant will then either refuse to process the transaction if the transaction payment has not been authorised, or process the transaction in the conventional manner. In either case, the cardholder 1 will be informed (10) of the outcome of their transaction request.

In this embodiment of the present invention, the network 4 can comprise any communications network. If the device used by the cardholder 1 for the generation of the limited use credit card number has a telecommunications capability, the network comprises a telecommunication network. If the device used by the cardholder 1 for the generation of the limited use credit card number has an Internet connection e.g. via a modem and a telecommunications network or via a local area network, the network 4 comprises the Internet. Also in this embodiment the means by which the limited use credit card number is given to the merchant 2 by the cardholder 1 can comprise any conventional known method such as by physically handing over a temporary credit card, mail order, telephone ordering, or e-commerce over the Internet. This embodiment of the present invention is particularly suited for providing security where the limited use credit card number is given over a communication medium and is thus exposed to potential fraudsters.

FIG. 2 is a schematic diagram of a specific implementation of the system of the first embodiment of the present invention. In this embodiment the system is implemented over the Internet 11 as the communications network for communication between a customers computer 10 for the generation and transmission of the limited use credit card number to the validation server 12 connected to the Internet 11. This embodiment provides the customer operating the customer's computer 12 with the ability to purchase goods using e-commerce. A merchant's computer 13 is connected to the Internet 11 and hosts a web site providing the e-commerce facility. The merchant's computer 13 is provided with a conventional means of validating credit card transactions via an acquirer 5 over the network 6 to the issuer 7 co-operating with the validation server 12 as described hereinabove generally with reference to FIG. 1. Although the computer 13 is referred to as the merchant's computer, it need not be operated by the merchant. It can simply be operated on their behalf to host the e-commerce web site.

FIG. 3 is a schematic diagram of the functional units of the customer's computer 10 in the embodiment of FIG. 2. This comprises the credit card number generator apparatus. The computer 10 in this embodiment comprises a conventional general purpose computer onto which a conventional web browser 30 is loaded such as Netscape (trademark) or Internet Explorer (trademark). Also a payment module 20 is loaded into the computer 10. The payment module can take the form of a web browser plug-in module. The loading process will take place as a result of the registration process after which the plug-in module is made available to the customer. This can be achieved by, for example, downloading the code over the Internet from a code providing server to the computer 10.

The payment module 20 comprises code for performing a number of functions. The diagram of FIG. 3 illustrates the code as separate functional units, but in practice, the code can be arranged in any convenient form and need not be written as distinct modules.

A user interface module 21 is provided to provide a display with which the user can interact. This can take the form of a window on the computer display. The display allows a user to enter their user ID and personal identification number (PIN) that are stored temporarily in the use ID and PIN store 22. When the user ID and PIN are entered, a number generator 24 is controlled to generate a limited user credit card number by obtaining a current time frame e.g. the current 2 minute window from a timer 25, the serial number for the payment module from the serial number store 26, and an encryption key from the key store 27. An Internet communications module 23 is provided to automatically send the generated limited use credit card number, the user ID and PIN over the Internet to the validation server 12. The Internet communications module 23 therefore has the capability of making an Internet Protocol (IP) connection over the Internet 11 using preset address and communication parameters. The user interface module 21 is arranged to display the generated limited use credit card number to the user and to display the result of the communication to the validation server 12 i.e. to display an indication of the outcome of the validation process.

The process carried out at the limited use credit card number generator apparatus will now be described with reference to the flow diagram of FIG. 7 and the diagram of the encryption algorithm of FIG. 4. When a user wishes to obtain a limited use credit card number they enter their user ID and PIN using the user interface (step S1). The current time window (time stamp 40) e.g. a 2 minute time window is obtained and the serial number 41 for the software module are summed in the summer 42. The sum is input to an encrypter 44 together with a 56-bit key to be used as the seed for the encryption process (step S2). The generated 16 digit number (45) is selectively truncated to form an 11 digit number and a standard prefix of four digits is added by a number generator 46. The prefix comprises a bank identification number (BIN) reserved by the issuer 7 specifically for the limited use credit card number service. Also a suffix digit comprising a Look-up number (LUN) is added to the number to form a 16 digit number that has the format of a credit card number (step S3). The Internet communications module 23 then transmits the generated limited use credit card number, the user ID and PIN to the validation server 12 for validation of the generated limited use credit card number. The outcome of the validation process is received from the validation server 12 and this is displayed to the user (step S5). In this way the user is informed whether or not the number generated is valid for use in a transaction and avoids the use of invalid limited use credit card numbers for transactions.

The encryption process used in this embodiment preferably comprises a complex 3-DES algorithm. Such algorithms are discussed in the following references, the disclosures of which are incorporated herein by reference:

1) American National Standards Institute. American National Standard X9.17: Financial Institution Key Management (Wholesale), 1985.

2) American National Standards Institute (ANSI) is broken down into committees, one being ANSI X9. The committee ANSI X9 develops standards for the financial industry, more specifically for personal identification number (PIN) management, check processing, electronic transfer of finds, etc. Within the committee of X9, there are subcommittees; further broken down are the actual documents, such as X9.9 and X9.17

3) E. Biham. Cryptanalysis of Multiple Modes of Operation. In Advances in Cryptology Asiacrypt '94, pages 278-292, Springer-Verlag, 1995.

4) B. S. Kaliski Jr. and M. J. B. Robshaw. Multiple encryption: weighing up security and performance. Dr. Dobb's Journal, #243, pages 123-127, January 1996.

The operation of the validation server 12 will now be described with reference to the schematic diagram of FIG. 5 and the flow diagram of FIG. 8. The validation server 12 is loaded with a conventional web server 50 acting as an interface to the Internet 11. Also a validation application 60 is loaded for communicating with the web server 12 to implement the validation function and to perform the transaction authorisation function with the issuer 7. In FIG. 5 the validation application 60 is illustrated as comprising separate functional modules, but in practice, the code can be arranged in any convenient form and need not be written as distinct modules.

A number receiver 61 and a user ID and PIN receiver 62 receive the generated limited use credit card number and the user ID and PIN respectively (step S6). The use ID and Pin are used to look-up user IDs and PINs in a customers database 64 (step S7) and a user validator 69 determines if a match can be found. If the user ID and PIN is not valid (step S8), a response sender 69a returns a response to the user's computer to inform them that they have failed to validly input their user details (step S9). If the user ID and PIN are determined to be valid (step S8), a number generator 67 generates a credit card number using the serial number for the user's software module and the encryption key for the user which are retrieved from the customers database 64. A timer 66 also generates a current time frame e.g. the current 2 minute time window and this is also used in the generation of the credit card number (step S10). The generation process is the same as that described with respect to FIGS. 3, 4 and 7. This generated number is then compared with the received generated number from the user in a comparator 63 (step S11). For the generated numbers to match, the time frame of generation must be the same. Thus this ensures that the validation process must take place in the same time frame as the user generation of the number.

If the numbers do not match (step S11), the response sender 69a sends a response to the customer's computer 10 to inform the customer that the generated number is not valid (step S13). If the numbers match, the limited use credit card number is entered into the customers database 64 and the response sender 69a returns a response to the customer's computer to inform the customer that the number has been successfully validated (step S12). Thus, the customers database 64 contains customers records, each containing a customer's personal details, their credit card or debit card number for the account to be used for payment and against which limited use credit card numbers are to be issued, their user ID and PIN, and any limited use credit card number issued for the customer.

A customer 1 is thus able to enter into a transaction with a merchant 2 for goods or services using a generated and validated limited use credit card number. The merchant will treat the limited use credit card number as any conventional credit card number: they need not know that the number is a limited use credit card number. The number will thus be sent via the conventional credit card transaction authorisation network 6 to the issuer 7 identified by the BIN in the number. The issuer 7 will identify from the BIN that the number is a limited use credit card number and it will thus pass this on to the validation server 12.

The process performed by the validation server 12 in the transaction authorisation process is illustrated in the flow diagram of FIG. 9. The issuer interface 68 (in FIG. 5) allows the validation server 12 to receive a request for the validation of a limited use credit card number from the issuer 7 (step S14). The validation interface 68 then looks-up the number in the customers database 64 (step S15) to determine if the number can be found. If the number is in not the customers database 64 (step S16), the issuers interface 68 returns an invalid signal to the issuer 7 (step S18). The issuer 7 can then refuse to authorise the transaction in the conventional manner. If the number is in the customers database 64 (step S16), the issuers database can retrieve the customer's conventional credit card number against which the limited use credit card has been issued and send this to the issuer 7 (step S17). The issuer 7 can then use the credit card number to carry out the authorisation process in the conventional manner e.g. by determining whether the customer has sufficient credit in their account for the transaction or whether there is some other bar on the authorising of transactions for the customer.

FIG. 6 is a diagram of an alternative limited use credit card number generator apparatus for use in the first embodiment of the present invention. This alternative number generating device 70 comprises a separate device having a user interface module 71 comprising a display and a keypad to allow a user to enter their user ID and PIN. A user ID and Pin store 72 is provided to temporarily store the user ID and PIN input by a user using the user interface module 71. When the user inputs their user ID and PIN, a number generator 74 generates a limited use credit card number in a manner described hereinabove with regard to FIGS. 3, 4, and 7 using the current time frame obtained from a timer 75, the devices serial number obtained from a serial number store 76 and an encryption key obtained from a key store 77. The generated number is output to the user via the user interface module 71 and sent over a communications network via a communications module 73 to a validation apparatus for validation of the generated number. A response from the validation apparatus is received by the communications module 73 and sent to the user interface module 71 for output to the user.

The device of FIG. 6 can comprise any stand-alone device having suitable dedicated hardware or programmed hardware to perform the functions of the modules. Although in FIG. 6 the modules are illustrated as separate units, they can comprises any arrangement or combination of software and hardware for performing the functions.

A second embodiment of the present invention will now be described with reference to FIGS. 10 to 25. FIG. 10 is a schematic diagram illustrating the principles of this embodiment of the present invention. A cardholder 1 has a device for generating a limited use credit card number. This device can comprise any suitable hardware or software combination. For example, the functionality can be programmed into a mobile telephone, a personal digital assistant or a computer. The device could alternatively comprise a dedicated device such as a smart card having a display and a keypad or another such similar device.

In this embodiment a cardholder 100 must first register for the service to obtain the number generating device or software. This requires a cardholder 100 to provide personal information including a credit or debit card account details (including a conventional credit card number) against which the limited use credit card numbers are to be issued. The cardholder 100 will select or be issued with a user ID and PIN to be used in the validation of limited use credit card numbers. If the number generating device comprises a suitably programmed device, the software for the device can be provided at the end of the registration process as a software download over a network e.g. the Internet. The software download will include a serial number for the software and an encryption key to be used in the encryption process for the generation of the limited use credit card number.

When a cardholder 100 wishes to purchase goods or services using a limited use credit card number, they contact (1) the merchant 200. This contact can be via any convention means of communication e.g. by telephone, in person, or via the Internet. The cardholder 100 will select to pay for the goods or services using a limited use credit card number. The merchant 200 will then refer (2) the transaction to a secure payment server 300 to authorise the transaction. The secure payment server 300 receives details on the transaction and obtains the cardholders user identification information (user ID and PIN) as well as a limited use credit card number generated by the cardholder 100 for the transaction. The limited use credit card number can be generated by any suitable apparatus and need not be a part of a communication system. The number can be generated and then manually sent to the secure payment server 300. The generated number has the format of a standard credit card number e.g. 15 or 16 digits with the prefix 4 digits comprising the bank identification number (BIN) for the issuer 7 and a suffix digit comprising the Look-up number (LUN).

The secure payment server 300 generates a time stamp indicating the time frame in which the request for payment using the limited use credit card number was made. The time stamp, the transaction information, the user identification information, and the input limited use credit card number are passed (3) by the secure payment server 300 to a validation server 400 over a secure communications link. At the validation server 400, the generated limited use credit card number is validated against the received user identification information using the received time stamp. In this way not only can the user can be validated, but also the time of generation of the limited use credit card number by the cardholder can be compared with the time of use of the limited use credit card number. The use must then be within a predetermined period of the generation of the limited use credit card number for the validation process to be successful. This therefore requires the cardholder to only generate the limited use credit card number a short time before it is to be used e.g. within a 2 minute window. This significantly decreases the likelihood of the limited use credit card number falling into a fraudster's hands and being valid. If the validation process is successful, the limited use credit card number is stored in a database against the cardholder's real credit card number in a record for the cardholder. The result of the validation process is returned (4) to the secure payment server 300. If the result is a successful validation of the limited use credit card, the secure payment server 300 generates (5) a conventional request for authorisation of the transaction via the acquirer 5 over (6) the network 6 to the issuer 7. The limited use credit card number is sent to the issuer identified by the BIN in the number. The issuer 7 identifies that the number is a limited use credit card number from the BIN and passes (7) the number to the validation server 400. The validation server 400 looks-up the limited use credit card number in the database held by the validation server 400 for cardholders and determined whether there is a match. If so the validation server 400 responds by sending the real credit card number for the cardholder to the issuer 7. The issuer 7 then performs the conventional credit card validation process and returns (9) the result of the authorisation process over the network 6 to the acquirer 5 that in turn passes the authorisation result to the secure payment server 300. The secure payment server 300 will then return (11) the result to the merchant for appropriate processing of the transaction. The cardholder 100 is then informed (12) of the result of the transaction.

It can thus be seen that this process provides for the need for the generation of the limited use credit card to be within a time window of the use of the limited use credit card number for a transaction. This increase security since if a fraudster were to get hold of a limited use credit card number it has a very short valid lifetime and thus the likelihood of the fraudster being able to validly use the number is small.

The secure payment server 300 is provided as the server accessible by merchants 200 and because it is accessible over the Internet it does not hold any sensitive information. The validation server 400 contains the sensitive information comprising cardholder records which include personal information, real credit card numbers and user identification information used for the validation of the limited use credit card numbers. This is kept secure by keeping it off the public Internet and providing only a secure connection between it and the secure payment server 300.

FIG. 11 is a schematic diagram of a specific implementation of the system of the second embodiment of the present invention. In this embodiment the system is implemented over the Internet 800 as the communications network for communication between a customers computer 110 for the generation and transmission of the limited use credit card number to the validation server 410 connected to the Internet 800. This embodiment provides the customer operating the customer's computer 110 with the ability to purchase goods using e-commerce. A merchant's computer 210 is connected to the Internet 800 and hosts a web site providing the e-commerce facility. The merchant's computer 210 is provided with a web page that is capable of referring the customer's computer 110 to a secure payment server 310 when a customer wishes to pay for goods or services offered on the merchant's web site using a limited use credit card number. The secure payment server 310 is provided with the means for carrying out a conventional request to the acquirer 5 for the validation of the limited use credit card once it has been validated by the validation server 410. The validation server 410 is provided with means for receiving and responding to authorisation requests from the issuer 7. The computers 110, 210, 310 and 410 can comprise any suitably programmed general-purpose computers.

In this embodiment of the present invention, unlike the first embodiment of the present invention, it is not necessary for the limited use credit card number generating apparatus to have a communications interface for the communication of the limited use credit card number and user identification information to the validation server. Instead, the limited use credit card number can be generated using any suitable device and output to the customer to allow them to input the generated limited use credit card number and user identification information to the secure payment server 310 for the validation of the number and the authorisation of the transaction. FIG. 18 is a diagram of a number generating device 111 in accordance with this embodiment of the present invention. FIG. 22 is a flow diagram illustrating the operation of the device. The device can comprise dedicated hardware or programmable hardware. The device can thus be provided as software operated within a programmable device such as a mobile telephone, personal digital assistant, or general-purpose computer. The device 111 comprises several functional modules that are shown separately for illustration. The functionality can instead be provided by any suitable hardware or software configuration. A user interface module 112 is provided to allow a user to request the generation of a limited use credit card number. This may require a user to input a user ID and PIN or password to activate the generation process (step S20). A number generator 113 is provided to receive a current time frame from a timer 114, a serial number for the device from a serial number store 115 and an encryption key from a key store 116 and to generate a number (step S21). The generated number is truncated and a prefix BIN and a suffix LUN are added to the number to form the limited use credit card number (step S22). The length of the BIN is variable and can be for example 4 or 6 digits depending upon the format used by the issuing bank. The number generation process in this embodiment is the same as in the previous embodiment and described with reference to FIGS. 3 and 4. The generated number is sent to the customer interface module for output e.g. display to the customer to allow the customer to enter it and their user ID and PIN on the web page generated by the secure payment server 310 (step S23).

FIG. 19 schematically illustrates the functional structure of the merchant's computer 210. The computer is loaded with program code comprising a web server 211 which refers to stored web pages 212, and a merchant application 213 which refers to stored shopping data 214 for providing the e-commerce web site which can be accessed by a customer using the customer's computer 110 loaded with a web browser such as Internet Explorer (trademark) or Netscape (trademark). The merchant's computer 210 is also provided with a merchant ID store for storing merchant identification information which is used for further validation of the transaction. Although the computer is termed the merchant's computer, it need not be operated by a merchant. The computer need only host the merchant's web site and can be under any third party control.

FIG. 23 is a flow diagram illustrating the operation of the merchant's computer. When a customer uses the e-commerce web site, such as that illustrated in the screen display of FIG. 12, the customer selects goods, which in this case comprises a book. (step S24). A web page is then displayed allowing the customer to enter their delivery details as illustrated in FIG. 13 (step S25). A web page is then displayed allowing the customer to select to pay by means of the limited use credit card number as illustrated in FIG. 14 (step S26). When the customer selects to pay by means of the limited use credit card number, the web browser loaded on the customer's computer receives a redirection instruction to redirect it to load a web page from the secure payment browser 310 (step S27). The page displayed is illustrated in FIG. 15. Data giving information on the transaction e.g. amount of the transaction, merchant identification information and information on the goods or services is passed to the secure payment server 310 with the redirection request using conventional the conventional HTTP protocol (step S28). Processing is then carried out by the secure payment server 310 as will be described in more detail hereinafter in order to validate and to authorise the transaction. The merchant's computer 210 thus awaits a response from the secure payment server 310 (step S29). If the response is to fail to validate or to authorise the transaction (step S29b) a display is generated to inform the customer that the transaction has not been authorised and they should choose another method of payment. If the response is that the transaction has been authorised (step S29a), the transaction is processed and a web page is displayed to the user as illustrated in FIG. 17 to indicate that the transaction has been successfully processed and an order number has been assigned to the order.

FIG. 20 schematically illustrates the functional structure of the secure payment server 310. The server is loaded with program code comprising a web server 311 referring to stored web page data 312, and a payment application 313 for controlling the validation and authorisation process. The payment application 313 uses a timer 314 to obtain a current time frame for sending, together with the input user identification information and limited use credit card number and the transaction information received from the merchant's computer to the validation server 410.

The operation of the secure payment server 310 will now be described with reference to the flow diagram of FIG. 24. When the web browser of the customer's computerl 10 is redirected to request a web page from the secure server, the transaction information is included in the request and is temporarily held by the secure payment server 310 (step S30). A web page is generated and sent to the customer's computer 110 as illustrated in FIG. 15 and the customer enters their limited use credit card number (termed Cast Iron number in the display of FIG. 15) user ID and PIN (step S31). The payment application then uses the timer 314 to determine the current time window e.g. a 2 minute frame (step S31) and the determined time frame, the input user ID, PIN and limited use credit card number and the transaction information are transmitted over a secure link (an IPSEC) to the validation server 410 (step S33). The secure payment server 310 then awaits a validation response from the validation server 410 (step S34) and the web page illustrated in FIG. 16 is sent to the customer's computer. If the response is that the limited use credit card number of the user identification information is invalid, an authorisation refusal is transmitted to the merchant's computer (step S35) and the web browser in the customer's computer 110 is redirected to a web page hosted by the merchant's computer 210 to display a notice to the customer that the authorisation has been refused and the customer should choose an alternative payment method (step S40b). If the response from the validation server is valid, a conventional credit card transaction authorisation request is sent to the acquirer 5 (step S36) and a response is awaited (step S37). If the response is that the transaction is not authorised, an authorisation refusal is transmitted to the merchant's computer (step S39) and the web browser in the customer's computer 110 is redirected to a web page hosted by the merchant's computer 210 to display a notice to the customer that the authorisation has been refused and the customer should choose an alternative payment method (step S40b). If the response is that the transaction is authorised, the authorisation is transmitted to the merchant's computer 210 (step S3 8) ) and the web browser in the customer's computer 110 is redirected to a web page hosted by the merchant's computer 210 to process the transaction (step S40a).

FIG. 21 is a schematic diagram of the validation server 410 in the second embodiment of the present invention. The validation server 12 is loaded with a conventional web server 411 acting as an interface to the Internet 800. Also a validation application 412 is loaded for communicating with the web server 411 to implement the validation function and to perform the transaction authorisation function with the issuer 7. In FIG. 21 the validation application 412 is illustrated as comprising separate functional modules, but in practice, the code can be arranged in any convenient form and need not be written as distinct modules.

The operation of the validation server 410 will now be described with reference to FIG. 21 and the flow diagram of FIG. 25. A data receiver 413 receives the generated limited use credit card number, the user ID and PIN, the time window, and the transaction data from the secure payment server 310 (step S41). The user ID and Pin are used to look-up user IDs and PINs in a customers database 415 (step S42) and a user validator 419a determines if a match can be found. If the user ID and PIN is not valid (step S43), a response sender 419b returns a response to the secure payment server 310 to inform that the validation process has failed (step S44). If the user ID and PIN are determined to be valid (step S43), a number generator 417 generates a credit card number using the serial number for the customer's software module, the encryption key for the customer which are retrieved from the customers database 415, and the received time window (step S45). The generation process is the same as that described with respect to FIGS. 3, 4 and 7. This generated number is then compared with the received generated number from the secure payment server 310 in a comparator 414 (step S46). For the generated numbers to match, the time frame of generation must be the same. Thus this ensures that the validation process must take place in the same time frame as the user generation of the number.

If the numbers do not match (step S46), the response sender 419b sends a response to the secure payment server 310 to inform that the generated number is not valid (step S48). If the numbers match, the limited use credit card number is entered into the customers database 415 and the response sender 419b returns a response to the secure payment server 310 to inform that the number has been successfully validated (step S47). Thus, the customers database 415 contains customers records, each containing a customer's personal details, their credit card or debit card number for the account to be used for payment and against which limited use credit card numbers are to be issued, their user ID and PIN, and any limited use credit card number issued for the customer. Also transaction information for customer transactions is stored.

The validation server 410 is also provided with an issuer's interface 418 to allow for the issuer to use the validation server 410 in the transaction authorisation process. In this embodiment, the process carried out by the validation server 410 for the authorisation of the transaction requested by the secure payment server 310 is the same as that for the first embodiment described with reference to FIG. 9.

FIG. 26 illustrates an alternative number generation algorithm in accordance with a modification of the second embodiment of the present invention. In this algorithm, instead of just using a time stamp 80, a serial number 85 and an encryption key 86, also the users PIN 81 and the merchant's identification information in the form of a secure hash 82 is used. The time stamp 80, the PIN 81 and the merchant's hash are summed together using a summer 83 and the resulting summation is input to a triple DES encryption algorithm together with the serial number 85 and the encryption key 86. The output digital number 87 is then truncated and a BIN and LUN added to form the limited use credit card number. This technique has the added security advantage of including information on both parties to the transaction, information on the number generating device, and time information. In this embodiment the customer must be given the merchant's secure hash as part of the transaction process to enable them to generate the limited use credit card number. Thus the number can only be generated at the time of the transaction with a merchant. The validation server will then require the user ID, PIN, merchant secure hash, and the time stamp from the secure payment server to enable the validation process to be carried out.

Although the present invention has been described with reference to specific embodiments, it will be apparent to a skilled person in the art that modifications lie within the spirit and scope of the present invention.

Although the embodiments of the present invention the process is illustrated as being implemented over the Internet, the present invention is applicable to any means of communication, including computer communications, telecommunications and physical communications. Any type of computer communications network can be used including the Internet, Intranets, Extranets, local area networks, and wireless networks including the wireless communications protocol (WAP).

The limited number generating apparatus can comprise any suitable hardware or programmable device such as a mobile telephone, a personal digital assistant (PDA), a general-purpose computer, or a dedicated hardware device such as a smart card with a display and a keypad.

In the present invention the limited use credit card number can be in any format that permits it to be processed as a conventional credit, debit, or charge card number in a conventional transaction authorisation system.

All of the components of the present invention can be provided as software for loading onto programmable apparatus. The present invention thus includes program code carried by a suitable carrier medium for controlling a programmable apparatus to implement the present invention. The carrier medium can include any physical medium such as a storage medium e.g. a floppy disk, a CD ROM, a solid state memory device or a magnetic tape device; or a transient medium such as an electrical, optical, microwave or radio frequency signal.

1. Apparatus for the authorisation of payments for goods or services made using a limited use credit card number, the apparatus comprising:
receiving means for receiving a limited use credit card number generated by apparatus used by a user and for receiving user identification information;
validation means for determining the validity of the received limited use credit card number using the received user identification information;
storage means for storing the received limited use credit card number if the received limited use credit card number is determined to be valid;
transaction authorisation means for receiving a request to authorise a transaction made using a limited use credit card number, the request including a limited use credit card number, for comparing the received limited use credit card number with the stored limited use credit card numbers, and for responding to the request in dependence upon the outcome of the comparison.

2. Apparatus according to claim 1, wherein said validation means is adapted to validate the limited use credit card number by generating a credit card number and comparing the generated number with the received number.

3. Apparatus according to claim 2, wherein the received limited use credit card number contains user information and said validation means is adapted to generate the credit card number to include user information.

4. Apparatus according to claim 2, wherein the received limited use credit card number contains information on the apparatus used to generate the credit card number, and said validation means is adapted to generate the credit card number to include information on apparatus associated with the user for the generation of the limited use credit card number.

5. Apparatus according to claim 2, wherein said storage means is adapted to store user identification information identifying users and apparatus identification information identifying the apparatus used by users; said validation means includes determining means for using the received user identification information to determine, from said storage means, information identifying the apparatus legitimately used by the user for the generation of the limited use credit card number; and said validation means is adapted to determine the validity of the received limited use credit card number by generating a credit card number using the determined apparatus identification information and comparing the generated number with the received number.

6. Apparatus according to claim 2, wherein the received limited use credit card number contains information on the time of generation of the credit card number, and said validation means is adapted to generate the credit card number to include information on time.

7. Apparatus according to claim 6, including timer means for generating said information on time as information on the time of generation of the credit card number by said validation means.

8. Apparatus according to claim 6, wherein said receiving means is adapted to receive the information on time from apparatus involved in the input of payment information from the user for the payment for the goods or services.

9. Apparatus according to claim 8, wherein said receiving means is adapted to receive transaction data for a purchase for which the limited use credit card is to be validated, said storage means is adapted to store the received transaction data in association with the limited use credit card number, and said transaction authorisation means is adapted to receive the request which includes transaction data, to compare the received transaction data with the stored transaction data, and to respond to the request in dependence upon the outcome of the comparison.

10. Apparatus according to claim 8, wherein said receiving means includes a secure port for receiving information from the apparatus involved in the input of payment information from the user for the payment for the goods or services.

11. Apparatus according to claim 6, wherein the information on the time of generation of the credit card number comprises a time window, and said validation means is adapted to generate the credit card number to include information on a time window when the limited use credit card number is being validated.

12. Apparatus according to claim 3, wherein the limited use credit card number is generated by encryption of the information using a key, and said validation means is adapted to generate the credit card number by encryption of the information using a key.

13. Apparatus according to claim 1, wherein said storage means is adapted to store user information for at least one user, the apparatus including user validation means for comparing the received user information with the stored user information and for controlling said validation means and said storage means to control the validation and storage of a limited use credit card number in dependence upon the outcome of the comparison by the user validation means.

14. Apparatus according to claim 1, wherein the user information comprises at least one of a user ID, a username, a PIN, and a password.

15. Apparatus according to claim 4, wherein the information on the apparatus comprises a serial number.

16. Apparatus according to claim 1, wherein said transaction authorisation means is adapted to operate on the stored limited use credit card number to indicate that it has been used when a transaction is authorised using the limited use credit card number, and to respond to the request in dependence upon the prior use made of the limited use credit card number.

17. Apparatus according to claim 1, wherein said storage means is adapted to store conventional credit card numbers for users and to associate limited use credit card numbers with conventional credit card numbers for users, and said transaction authorisation means is adapted to respond to the request by sending the conventional credit card number associated with the limited use credit card number.

18. A method of the authorisation of payments for goods or services made using a limited use credit card number, the method comprising:
receiving a limited use credit card number generated by apparatus used by a user and receiving user identification information;
determining the validity of the received limited use credit card number using the received user identification information;
storing the received limited use credit card number if the received limited use credit card number is determined to be valid;
receiving a request to authorise a transaction made using a limited use credit card number, the request including a limited use credit card number;
comparing the received limited use credit card number with the stored limited use credit card numbers; and
responding to the request in dependence upon the outcome of the comparison.

19. A method according to claim 18, wherein the limited use credit card number is validated by generating a credit card number and comparing the generated number with the received number.

20. A method according to claim 19, wherein the received limited use credit card number contains user information and the credit card number is generated to include user information.

21. A method according to claim 19, wherein the received limited use credit card number contains information on the apparatus used to generate the credit card number, and the credit card number is generated to include information on apparatus associated with the user for the generation of the limited use credit card number.

22. A method according to claim 19, including storing user identification information identifying users and apparatus identification information identifying the apparatus used by users; using the received user identification information to determine, from the stored information, information identifying the apparatus legitimately used by the user for the generation of the limited use credit card number; determining the validity of the received limited use credit card number by generating a credit card number using the determined apparatus identification information; and comparing the generated number with the received number.

23. A method according to claim 19, wherein the received limited use credit card number contains information on the time of generation of the credit card number, and the credit card number is generated to include information on time.

24. A method according to claim 23, including generating said information on time as information on the time of generation of the credit card number in the validation step.

25. A method according to claim 23, wherein the information on time is received from apparatus involved in the input of payment information from the user for the payment for the goods or services.

26. A method according to claim 25, wherein transaction data is received for a purchase for which the limited use credit card is to be validated, the received transaction data is stored in association with the limited use credit card number, the request includes transaction data, the received transaction data is compared with the stored transaction data, and the request is responded to in dependence upon the outcome of the comparison.

27. A method according to claim 25, wherein the information from the apparatus involved in the input of payment information from the user for the payment for the goods or services is received over a secure communications link.

28. A method according to claim 23, wherein the information on the time of generation of the credit card number comprises a time window, and the credit card number is generated to include information on a time window when the limited use credit card number is being validated.

29. A method according to claim 20, wherein the limited use credit card number is generated by encryption of the information using a key, and the credit card number is generated for the validation process by encryption of the information using a key.

30. A method according to claim 18, wherein user information for at least one user is stored, the method including comparing the received user information with the stored user information and controlling the validation and storage of a limited use credit card number in dependence upon the outcome of the comparison of the user information.

31. A method according to claim 18, wherein the user information comprises at least one of a user ID, a username, a PIN, and a password.

32. A method according to claim 21, wherein the information on the apparatus comprises a serial number.

33. A method according to claim 18, wherein the stored limited use credit card number is operated on to indicate that it has been used when a transaction is authorised using the limited use credit card number, and the request is responded to in dependence upon the prior use made of the limited use credit card number.

34. A method according to claim 18, wherein conventional credit card numbers for users are stored associated with limited use credit card numbers for users, and the request for authorising a transaction is responded to by sending the conventional credit card number associated with the limited use credit card number.

35. Apparatus for the authorisation of payments for goods or services made using a limited use credit card number, the apparatus comprising:
a memory storing processor implementable instructions;
a processor for implementing the instructions stored in the memory;
wherein the instructions comprise instructions for controlling the processor to:
receive a limited use credit card number generated by apparatus used by a user and for receiving user identification information;
determine the validity of the received limited use credit card number using the received user identification information;
store the received limited use credit card number if the received limited use credit card number is determined to be valid;
receive a request to authorise a transaction made using a limited use credit card number, the request including a limited use credit card number;
compare the received limited use credit card number with the stored limited use credit card numbers; and
respond to the request in dependence upon the outcome of the comparison.

36. Apparatus according to claim 34, wherein the instructions comprise instructions for controlling the processor to validate the limited use credit card number by generating a credit card number and comparing the generated number with the received number.

37. Apparatus according to claim 35, wherein the received limited use credit card number contains user information and the instructions comprise instructions for controlling the processor to generate the credit card number to include user information.

38. Apparatus according to claim 36, wherein the received limited use credit card contains information on the apparatus used to generate the credit card number, the instructions comprise instructions for controlling the processor to generate the credit card number to include information on apparatus associated with the user for the generation of the limited use credit card number.

39. Apparatus according to claim 36, the instructions comprise instructions for controlling the processor to;
store user identification information identifying users and apparatus identification information identifying the apparatus used by users;
use the received user identification information to determine, from the stored information, information identifying the apparatus legitimately used by the user for the generation of the limited use credit card number; and
determine the validity of the received limited use credit card number by generating a credit card number using the determined apparatus identification information and comparing the generated number with the received number.

40. Apparatus according to claim 36, wherein the received limited use credit card number contains information on the time of generation of the credit card number, and the instructions comprise instructions for controlling the processor to generate the credit card number to include information on time.

41. Apparatus according to claim 40, wherein the instructions comprise instructions for controlling the processor to generate said information on time as information on the time of generation of the credit card number by said validation means.

42. Apparatus according to claim 40, wherein the instructions comprise instructions for controlling the processor to receive the information on time from apparatus involved in the input of payment information from the user for the payment for the goods or services.

43. Apparatus according to claim 42, wherein the instructions comprise instructions for controlling the processor to:
receive transaction data for a purchase for which the limited use credit card is to be validated;
store the received transaction data in association with the limited use credit card number;
receive the request which includes transaction data;
compare the received transaction data with the stored transaction data; and
respond to the request in dependence upon the outcome of the comparison.

44. Apparatus according to claim 42, wherein including a secure port for receiving information from the apparatus involved in the input of payment information from the user for the payment for the goods or services.

45. Apparatus according to claim 40, wherein the information on the time of generation of the credit card number comprises a time window, and the instructions comprise instructions for controlling the processor to generate the credit card number to include information on a time window when the limited use credit card number is being validated.

46. Apparatus according to claim 37, wherein the limited use credit card number is generated by encryption of the information using a key, and the instructions comprise instructions for controlling the processor to generate the credit card number by encryption of the information using a key.

47. Apparatus according to claim 35, the instructions comprise instructions for controlling the processor to:
store user information for at least one user,
compare the received user information with the stored user information; and
controlling the validation and storage of a limited use credit card number in dependence upon the outcome of the comparison of the user information.

48. Apparatus according to claim 35, wherein the user information comprises at least one of a user ID, a username, a PIN, and a password.

49. Apparatus according to claim 38, wherein the information on the apparatus comprises a serial number.

50. Apparatus according to claim 35, wherein the instructions comprise instructions for controlling the processor to operate on the stored limited use credit card number to indicate that it has been used when a transaction is authorised using the limited use credit card number, and to respond to the request in dependence upon the prior use made of the limited use credit card number.

51. Apparatus according to claim 35, wherein the instructions comprise instructions for controlling the processor to store conventional credit card numbers for users, to associate limited use credit card numbers with conventional credit card numbers for users, and to respond to the request by sending the conventional credit card number associated with the limited use credit card number.

52. Apparatus for generating a limited use credit card number, the apparatus comprising:
storage means for storing apparatus identification information for identifying the apparatus, and an encryption key;
timer means for generating time identification information;
encryption means for encrypting the apparatus identification information and the time identification information using the encryption key to generate a multiple digit number;
limited use credit card number generating means for using the generated number to form a limited use credit card number containing at least a part of the encrypted number; and
output means for outputting the generated limited use credit card number.

53. Apparatus according to claim 52, wherein the limited use credit card number generating means is adapted to generate the limited use credit card number by fitting the multiple digit number between a number of standard prefix and suffix digits.

54. Apparatus according to claim 53, wherein the limited use credit card number generating means is adapted to fit the limited use credit card number between a number of standard prefix and suffix digits by truncating the multiple digit number.

55. Apparatus according to claim 52, wherein said storage means is adapted to store user identification information, including user input means for receiving user identification information entered by the a user, and authorisation means for comparing the received user identification information with the stored user identification information, wherein said encryption means and said limited use credit card number generating means are adapted to generate the limited use credit card number in dependence upon the outcome of the comparison.

56. Apparatus according to claim 55, wherein said encryption means is adapted to generate the multiple digit number by also encrypting the user identification information.

57. Apparatus according to claim 52, including input means for inputting merchant identification information identifying the merchant from whom goods or services are to be purchased using the limited use credit card number, wherein said encryption means is adapted to generate the multiple digit number by also encrypting the merchant identification information.

58. Apparatus according to claim 52, wherein said outputting means is adapted to transmit the generated limited use credit card number to validation apparatus for the validation of the generated limited use credit card number.

59. Apparatus according to claim 58, including user input means for the user input of user authorisation code, wherein said outputting means is adapted to transmit the user authorisation code to the validation apparatus for use in the validation process.

60. A method of generating a limited use credit card number, the method comprising:
storing apparatus identification information for identifying the apparatus, and an encryption key;
generating time identification information;
encrypting the apparatus identification information and the time identification information using the encryption key to generate a multiple digit number;
using the generated number to form a limited use credit card number containing at least a part of the encrypted number; and
outputting the generated limited use credit card number.

61. A method according to claim 60, wherein the limited use credit card number is generated by fitting the multiple digit number between a number of standard prefix and suffix digits.

62. A method according to claim 61, wherein the limited use credit card number is generated between a number of standard prefix and suffix digits by truncating the multiple digit number.

63. A method according to claim 60, wherein user identification information is stored, the method including receiving user identification information entered by the a user, and comparing the received user identification information with the stored user identification information, wherein the limited use credit card number is generated in dependence upon the outcome of the comparison.

64. A method according to claim 63, wherein the multiple digit number is generated by also encrypting the user identification information.

65. A method according to claim 60, including receiving merchant identification information identifying the merchant from whom goods or services are to be purchased using the limited use credit card number, the multiple digit number is generated by also encrypting the merchant identification information.

66. A method according to claim 60, including transmitting the generated limited use credit card number to validation apparatus for the validation of the generated limited use credit card number.

67. A method according to claim 66, including receiving user authorisation code, wherein the user authorisation code is transmitted to the validation apparatus for use in the validation process.

68. Apparatus for generating a limited use credit card number, the apparatus comprising:
a memory storing processor implementable instructions;
a processor for implementing the instructions stored in the memory; and
a data store for storing apparatus identification information for identifying the apparatus, and an encryption key;
wherein the instructions comprise instructions for controlling the processor to:
generate time identification information;
encrypt the apparatus identification information and the time identification information using the encryption key to generate a multiple digit number;
use the generated number to form a limited use credit card number containing at least a part of the encrypted number; and
output the generated limited use credit card number.

69. Apparatus according to claim 68, wherein the instructions comprise instructions controlling the processor to generate the limited use credit card number by fitting the multiple digit number between a number of standard prefix and suffix digits.

70. Apparatus according to claim 69, wherein the instructions comprise instructions for controlling the processor to fit the limited use credit card number between a number of standard prefix and suffix digits by truncating the multiple digit number.

71. Apparatus according to claim 68, wherein said data store stores user identification information, wherein the instructions comprise instructions for controlling the processor to:
receive user identification information entered by the a user;
compare the received user identification information with the stored user identification information; and
generate the limited use credit card number in dependence upon the outcome of the comparison.

72. Apparatus according to claim 71, wherein the instructions comprise instructions for controlling the processor to generate the multiple digit number by also encrypting the user identification information.

73. Apparatus according to claim 68, wherein the instructions comprise instructions for controlling the processor to:
receive merchant identification information identifying the merchant from whom goods or services are to be purchased using the limited use credit card number; and
generate the multiple digit number by also encrypting the merchant identification information.

74. Apparatus according to claim 68, wherein the instructions comprise instructions for controlling the processor to transmit the generated limited use credit card number to validation apparatus for the validation of the generated limited use credit card number.

75. Apparatus according to claim 74, wherein the instructions comprise instructions for controlling the processor to receive user authorisation code, and transmit the user authorisation code to the validation apparatus for use in the validation process.

76. A secure payment method for paying for good or services, the method comprising:
using apparatus in the possession of a customer to generate a limited use credit card number;
sending the limited use credit card number and customer identification information to a validation apparatus over a communications network;
at the validation apparatus, validating the generated limited use credit card number using the customer identification information; and
if the generated limited use credit card number is determined to be valid:
storing the limited use credit card number for payment for goods or services at the validation apparatus,
using the limited use credit card number for paying for goods or services, and
validating the purchase by comparing the credit card number used for the purchase with the limited use credit card number stored at the validation apparatus.

77. A method according to claim 76, wherein the limited use credit card is sent to the validation apparatus by the apparatus in the possession of the customer to obtain a valid limited use credit card number before making a purchase.

78. A method according to claim 76, wherein the limited use credit card number is used for a purchase before validation, a purchase validation apparatus receives the limited use credit card number from a merchant party to the purchase and transmits the limited use credit card number to the validation apparatus for validation.

79. Apparatus for receiving and processing orders for goods or services, the apparatus comprising:
receiving means for receiving an order for goods or services and a request to pay for the transaction using a limited use credit card;
referring means for referring the request, information on the transaction, and identification information identifying the apparatus to a secure payment apparatus for validation;
validation receiving means for receiving a response from the secure payment apparatus as a result of the validation; and
transaction processing means for processing the transaction in dependence upon the received response.

80. Apparatus for receiving and processing orders for goods or services, the apparatus comprising:
a memory storing processor implementable instructions;
a processor for implementing the instructions stored in the memory; wherein the instructions comprise instructions for controlling the processor to:
receive an order for goods or services and a request to pay for the transaction using a limited use credit card;
refer the request, information on the transaction, and identification information identifying the apparatus to a secure payment apparatus for validation;
receive a response from the secure payment apparatus as a result of the validation; and
processing the transaction in dependence upon the received response.

81. A method of receiving and processing orders for goods or services, the method comprising:
receiving an order for goods or services and a request to pay for the transaction using a limited use credit card;
referring the request, information on the transaction, and identification information identifying the apparatus to a secure payment apparatus for validation;
receiving a response from the secure payment apparatus as a result of the validation; and
processing the transaction in dependence upon the received response.

82. A secure payment web server for providing a validation interface for an e-commerce web site, the server comprising:
internet interface means for receiving referred requests for validation of transactions using a limited use credit card number, and for allowing a user to enter their limited use credit card number generated by the user, wherein the request includes transaction information and the limited use credit card includes time of generation information;
time information generating means for generating time information; and
secure interface means for sending the received transaction information, the limited use credit card information and the generated time information over a secure communications link to a validation server, and for receiving a result of a validation process;
wherein the internet interface means is adapted to output a message to the user dependant upon the received result of the validation and to pass on the received result of the validation to an e-commerce server hosting the e-commerce web site.

83. A secure payment web server according to claim 82, wherein the internet interface is adapted to allow a user to input user identification information, and the secure interface is adapted to send the input user identification information to the validation server for use in the validation process.

84. A secure payment web server according to claim 82, wherein the internet interface is adapted to receive merchant identification information in the request, and the secure interface is adapted to send the merchant identification information to the validation server for use in the validation process.

85. A carrier medium carrying computer readable code for controlling a computer to carry out the method according to any one of claims 18 to 34, 60 to 67 or 81.

86. A carrier medium carrying computer readable code for controlling a computer to be configured as the apparatus according to any one of claims 1 to 17, 35 to 59, or 68 to 80.

87. A carrier medium carrying computer readable code for controlling a computer to be configured as the secure payment web server according to any one of claims 82 to 84.
